(19) United States
(12) Patent Application Publication
(10) Pub. No.: US 2026/0172437 A1
(43) Pub. Date: Jun. 18, 2026

(54) METHOD AND SYSTEM TO IMPLEMENT AI AGENTS

(71) Applicant: Box, Inc., Redwood City, CA (US)

(72) Inventors: Denis Grenader, Dover, NH (US); Sesh Jalagam, Union City, CA (US)

(73) Assignee: Box, Inc., Redwood City, CA (US)

(21) Appl. No.: 19/466,007

(22) Filed: Jan. 30, 2026

Related U.S. Application Data
(63) Continuation-in-part of application No. 19/270,425, filed on Jul. 15, 2025.
(63) Continuation-in-part of application No. 19/270,430, filed on Jul. 15, 2025.
(60) Provisional application No. 63/719,099, filed on Nov. 11, 2024.
(60) Provisional application No. 63/719,099, filed on Nov. 11, 2024.

(51) Int. Cl. H04L 9/40; H04L 67/50

(52) U.S. Cl. CPC H04L 63/1425; H04L 63/1466; H04L 67/535

(57) ABSTRACT

Methods, systems and computer program products for analyzing historical user interactions within a content management system. The approach detects and mitigates against malicious interactions involving artificial intelligence (AI), including prompt injection attacks, by analyzing historical interaction data rather than relying solely on static or rule-based safeguards.

### CROSS-REFERENCE TO RELATED APPLICATIONS

The present application is a continuation-in-part of U.S. application Ser. No. 19/270,425, which claims benefit of priority to U.S. Provisional Patent Application Ser. No. 63/719,099, all of which are hereby incorporated by reference in their entirety.

### BACKGROUND

AI agents are increasingly used in various applications to assist users with tasks, provide information, and automate processes. These agents are designed to perceive their environment, reason about it, and take actions to achieve specific goals. Effective customization of these agents is important for maximizing their utility and user satisfaction. In general, an AI agent can be defined as an autonomous entity that observes and acts upon an environment. They can range from simple rule-based systems to sophisticated deep learning models.

Key characteristics of AI agents include (a) Autonomy: Agents can operate without direct human intervention; (b) Perception: Agents perceive their environment through sensors or inputs; (c) Reasoning: Agents process their perceptions and knowledge to make decisions; (d) Action: Agents act upon their environment to achieve goals.

The development of AI agents has been driven by advances in artificial intelligence, machine learning, and natural language processing. These technologies have enabled agents to perform increasingly complex tasks, such as understanding human language, recognizing objects in images, and making predictions based on data. As AI agents become more sophisticated, their potential applications across various domains continue to expand.

In content management systems, AI agents can be used to automate a variety of tasks, such as document classification, information retrieval, and workflow management. They can also assist users by providing personalized recommendations, answering questions, and facilitating collaboration.

AI agents use Large Language Models (LLMs) as their “cognitive core” or brain, enabling them to reason, plan, and make decisions to accomplish autonomous tasks. While LLMs are passive, generating text based on prompts, AI agents are proactive, using LLMs to interpret goals, utilize tools (APIs, web browsers), maintain memory, and operate in loops to solve complex problems.

There are a deep connective relationships between AI agents, LLMs, and the “prompts” that are used with the AI agents and LLMs. A prompt is the specific set of instructions or text that is provided to an AI to guide its response and define the task to be performed by the AI. It acts as a bridge between an intended action and the model's vast database of information, essentially priming the AI to produce a relevant answer. By adjusting the context and detail within a prompt, one can control the tone, format, and accuracy of the output that is received.

Therefore, prompts serve as the critical, instructive link, with agents often utilizing complex “prompt engineering” (e.g., Chain-of-Thought) to guide their behavior. The agent relies on the LLM to process information, plan, and make decisions. The LLM acts as the central intelligence within an agentic framework. LLMs receive input prompts to generate text, code, or actions, operating based on the context provided in those instructions. Agents use prompts as structured, often programmatic instructions (system prompts) to guide their behavior, define their goals, and manage their interaction with tools.

Unfortunately, prompts may also serve as a way for bad actors to introduce malicious actions or security threats within a system. Specifically, the bad actor may use “prompt injection” to introduce a security vulnerability, where an attacker manipulates an AI's behavior by inserting malicious instructions into a prompt, tricking the model into ignoring its original safeguards. Because LLMs process both developer instructions and user-provided data as a single stream of text, they often struggle to distinguish between a legitimate request and a “hijacking” command. This allows attackers to “jailbreak” the system, forcing the AI to bypass ethical filters, reveal private data, or perform unauthorized actions like sending emails without the user's consent.

The threat becomes even more complex with indirect prompt injection, where malicious commands are hidden in external sources like websites or documents that the AI is asked to analyze. In these cases, a user might unknowingly trigger a security breach simply by asking the AI to summarize a corrupted webpage. Because there is currently no perfect way to separate “code” from “content” in natural language processing, prompt injection remains one of the most significant challenges in building secure, AI-driven applications.

Current strategies for handling prompt injections focus on “defense-in-depth,” which involves layering multiple security controls rather than relying on a single fix. The most common approach is the use of automated guardrails, where secondary AI models scan incoming text for malicious patterns or malicious intent before the primary model ever sees it. Developers also employ structural techniques like delimiters to clearly mark user data and follow the principle of least privilege, ensuring that even if an AI is compromised, it lacks the technical permissions to perform high-risk actions like deleting files or accessing private databases without human intervention.

The fundamental limitation of these approaches is that LLMs are designed to be fluid and helpful, making them inherently susceptible to linguistic manipulation. Unlike traditional software that uses strict syntax, LLMs cannot perfectly distinguish between a legitimate instruction and a malicious one hidden in a clever metaphor or a different language. Consequently, security becomes a cat-and-mouse game, whereas guardrails become more sophisticated, attackers find new ways to bypass them using new techniques or encoding malicious commands in ways that safety filters do not currently recognize.

Therefore, there is a need for an improved approach to implement security or malicious security threats involving AI.

### SUMMARY

Embodiments of the present invention provide systems and methods for detecting and mitigating malicious interactions involving artificial intelligence (AI), including prompt injection attacks, by analyzing historical interaction data rather than relying solely on static or rule-based safeguards. Unlike conventional approaches that attempt to evaluate each prompt in isolation, the disclosed techniques model AI behavior within its operational context by examining historical patterns of prompts, actions, content interactions, and entity relationships within a content management system (CMS). This context-aware analysis enables the system to identify deviations from established behavioral baselines that may indicate malicious or unintended manipulation of AI behavior.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1 provides a high-level system architecture illustrating core components involved in the implementation of AI agents within a Content Management System.

FIG. 2 presents a detailed architectural illustration of an AI agent.

FIG. 3 illustrates the general operational flow of an AI agent within a content management system, according to some embodiments.

FIG. 4 illustrates a system architecture for initiating the assignment of an AI agent to a user.

FIG. 5 illustrates another example scenario where a supervisor AI agent plays a role in initiating the creation and deployment of other AI agents.

FIG. 6 presents a high-level flowchart that illustrates the operational flow of the system, according to some embodiments of the invention.

FIG. 7A presents a flowchart of the architectural framework of a system designed for the intelligent assignment of Artificial Intelligence (AI) agents within a content management ecosystem, in accordance with certain illustrative embodiments of the present invention.

FIG. 7B provides a visual representation of a potential methodology for generating file clusters through the utilization of activity graphs.

FIG. 7C illustrates on the concept of weighted interactions within the activity graph.

FIG. 7D illustrates the application of clustering algorithms to the derived user-to-user graph.

FIG. 7E illustrates where the previously established user and content clusters are leveraged to intelligently determine and assign the most appropriate type of Artificial Intelligence (AI) agent to a user interacting with the content management system.

FIG. 7F highlights the recognition that the interactions recorded within the content management system are not solely limited to those initiated by human users.

FIG. 7G illustrates the application of clustering algorithms to a derived Agent-to-Agent graph, resulting in the identification of distinct AI Agent clusters.

FIG. 7H illustrates the concept of a combined graph that includes both user-to-file interactions as well as AI Agent-to-file interactions.

FIG. 7I shows an interaction associated with additional information regarding the interaction that may be used by the system to perform clustering and analysis processing.

FIG. 7J illustrates different types of graphs.

FIG. 7K shows the use of graphs for onboarding of an entity in the content management system.

FIG. 8 presents a detailed flowchart that outlines the sequential steps involved in the intelligent assignment of an AI agent to a user request, according to certain illustrative embodiments of the present invention.

FIG. 9 presents a high-level flowchart that outlines a dynamic approach to customize an AI agent.

FIG. 10 presents a more detailed flowchart that elaborates on the steps involved in a context-aware approach to customizing an AI agent at its execution time.

FIG. 11 shows a flowchart to implement some embodiments of the invention.

FIG. 12 visually depicts an example clustering model used by the system to associate interaction characteristics with one or more AI agent types.

FIG. 13A illustrates a contrasting scenario in which the vector corresponding to the new request does not fall within the bounds of one of the existing historical clusters.

FIG. 13B illustrates a contrasting scenario in which the vector corresponding to the new request falls within the bounds of one of the existing historical clusters.

FIG. 13C illustrates how unsupervised machine learning can be used improve the process of identifying anomalies.

FIGS. 14, 15, 16, and 17 provides illustrative examples of relationship graphs that may be used within the system to implement this functionality.

FIG. 18 illustrates a flowchart implementing one or more embodiments of behavior-level anomaly detection.

FIGS. 19A and 19B present block diagrams of computer system architectures having components suitable for implementing embodiments of the present disclosure, and/or for use in the herein-described environments.

### DETAILED DESCRIPTION

The present invention provides an improved approach for detecting and mitigating malicious interactions involving artificial intelligence (AI), including prompt injection attacks, by analyzing historical interaction data rather than relying solely on static or rule-based safeguards. Unlike conventional approaches that attempt to evaluate each prompt in isolation, the disclosed techniques model AI behavior within its operational context by examining historical patterns of prompts, actions, content interactions, and entity relationships within a content management system (CMS). This context-aware analysis enables the system to identify deviations from established behavioral baselines that may indicate malicious or unintended manipulation of AI behavior.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

This portion of the document provides an improved approach to implement AI agents.

Traditional approaches to AI agent customization often rely on analyzing the historical interactions of individual users. These methods typically involve tracking a user's past actions, preferences, and behaviors to tailor the agent's responses and functionality. For example, an AI agent might learn a user's preferred file types or frequently used applications based on their past activity. This approach assumes that a user's future behavior will closely resemble their past behavior, and that their needs are entirely independent of other users within the system.

A limitation of these traditional methods is that they may not capture the full range of user behaviors and preferences. By focusing solely on individual user data, they may miss patterns and similarities that exist across different users. This can lead to suboptimal agent assignments and less effective customization. Consider, for instance, a scenario where multiple users within a content management system frequently collaborate on a specific type of project. An AI agent customized to understand this collaborative pattern could provide more effective support than an agent customized only to an individual's past actions.

For example, consider a scenario where a user is new to a particular job role in a content management system. The user's initial interaction history may be limited, making it difficult for an AI agent to accurately determine the user's needs and preferences. Furthermore, the user may exhibit behaviors similar to other users who have interacted with the system in the past, but this similarity would not be captured by a single-user analysis. An AI agent assigned to this user, and customized based only on the limited data, may not be as effective as an agent that had access to a broader set of historical interactions.

In addition, previous methods may struggle to correctly assign the most appropriate AI agent type to a user. Different AI agent types may be designed for different tasks or user roles. Relying solely on an individual user's history may not provide sufficient information to make an accurate assignment, especially in cases where the user's behavior is atypical or their role is complex. For instance, a user might need an agent with strong data analysis skills, but their personal history in a CMS might primarily involve file sharing. A system that only looks at that user's file sharing history might incorrectly assign an agent with file management expertise, rather than data analysis capabilities.

Embodiments of the present invention addresses the limitations of traditional AI agent customization by analyzing historical user interactions across multiple users within a content management system. This approach employs machine learning to identify patterns and similarities in user behavior, enabling more accurate AI agent assignment and customization. By considering the collective behavior of user groups, the invention can provide AI agents that are better tailored to specific tasks and user needs, ultimately improving their effectiveness and user satisfaction.

The invention disclosed herein represents a significant departure from conventional methods of deploying AI agents within content management systems. Rather than relying on static configurations or limited individual user data, this system harnesses the power of collective user behavior. By analyzing historical interaction data across a multitude of users, the system employs machine learning techniques to identify patterns, group users with similar workflows, and tailor AI agents to the specific needs of these groups. This data-driven approach ensures that AI agents are deployed and customized in a manner that is both accurate and adaptive.

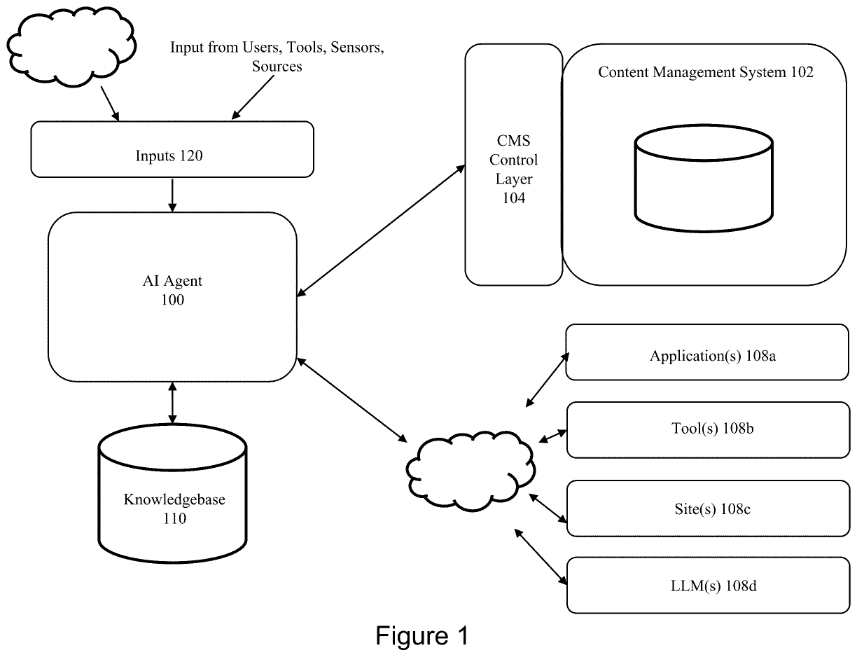

In essence, this disclosure describes a system designed to improve the implementation of AI agents within content management systems by leveraging machine learning techniques to analyze historical user interaction data. This enables the dynamic assignment and customization of AI agents based on collective user behavior, ensuring that AI agents are tailored to specific user groups and tasks, leading to enhanced effectiveness and user experience. The high-level architecture of this system, including the key components and their interactions, is depicted in FIG. 1.

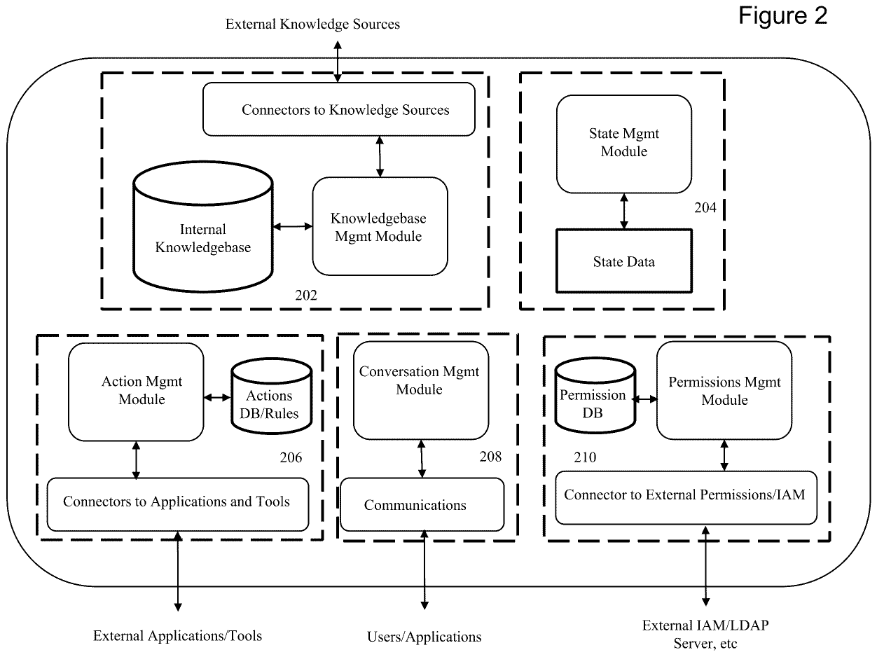

FIG. 1 shows a high-level overview of a system architecture for deployment of AI agents within a content management system (CMS) 102. This system includes an AI agent 100, which a software-based entity that can assist users in carrying out tasks within the CMS. As discussed in more detail below, this AI agent is structured as a modular framework (explored further in FIG. 2), enabling it to interpret inputs, draw on both internal and external knowledge sources, make decisions, and take actions in and beyond the CMS environment.

To communicate effectively with the CMS 102, the AI agent 100 interacts through a CMS control layer 104. This intermediary layer abstracts the complexity of the CMS and provides a consistent, secure interface through which the agent can engage with system functions. It includes control mechanisms such as APIs and communication protocols, allowing the agent to query data, manage permissions (in collaboration with the permissions module described later), trigger workflows, and carry out content-related operations.

The CMS 102 serves as the operational backdrop for these interactions, offering the tools and infrastructure needed to store, organize, protect, and retrieve digital content. Systems such as Box, enterprise-grade content platforms, and document repositories fall under this category. These systems not only handle metadata and permission management but also often support collaborative tasks. Whether deployed as a cloud-based solution for flexibility and scale, or as an on-premises platform tailored to internal needs, the CMS forms the core environment in which both users and AI agents operate.

The AI agent 100 takes in input signals 120 from a variety of sources, which inform its actions and decision-making. As illustrated, these sources can include direct user commands or queries entered through an interface, signals from other software tools or applications integrated with the CMS, data streams from various sensors providing contextual information, outputs or requests from other AI agents within a multi-agent system, or any other entity capable of providing relevant data or control signals to the AI agent 100. The inputs 120 can originate from on-premises systems, cloud-based services, or hybrid environments, reflecting the distributed nature of modern computing.

A component supporting the AI agent's operation is the knowledge base 110. This knowledge base 110 represents the repository of information and data that the AI agent 100 utilizes to understand context, reason, and perform its tasks effectively. The knowledge base 110 can encompass a wide array of data, including factual information about the CMS and its content, machine learning models and datasets used for tasks like natural language understanding or content recommendation, and structured knowledge representations such as ontologies or rule sets that guide the AI agent's behavior and decision-making processes. The AI agent 100 accesses and processes information from the knowledge base 110 to interpret inputs, plan actions, and generate appropriate responses or outcomes.

Furthermore, FIG. 1 highlights the AI agent's ability to interact with various downstream services or entities 108a-108d. These external interactions extend the AI agent's capabilities beyond the confines of the CMS 102, allowing it to leverage specialized functionalities and data from other systems. Examples include interfacing with productivity applications 108a (e.g., email clients, calendar applications), specialized tools 108b (e.g., data analysis tools, image processing software), external websites or sites 108c (e.g., for information retrieval or content sharing), and Large Language Models (LLMs) 108d (e.g., for advanced natural language processing and generation). These interactions typically occur over a network, such as the cloud, enabling seamless integration with a broader ecosystem of services.

By analyzing interaction histories collected within the CMS 102, the system applies machine learning, leveraging the knowledge base 110, to identify behavior patterns across different users. This analysis helps to group users with similar workflows or roles, making it possible to assign an appropriate AI agent when a new user begins working within the system or requests assistance. The system, based on user interactions within the CMS 102 (captured as historical data), analyzes patterns of behavior across multiple users. This analysis, potentially leveraging the knowledge base 110 for machine learning algorithms, identifies user groups with similar needs and task patterns. When a new user interacts with the CMS or requires AI assistance (potentially triggering an input 120), the system uses this collective intelligence to determine the most suitable type of AI agent 100 to assign. This assignment process considers the user's role, the context of their current task within the CMS 102, and their likely needs based on the behavior of similar users.

In some embodiments, the AI agent 100 is not static, but can evolve based at least in part on user-specific and community-wide behavioral patterns. By considering what content and functionalities are frequently accessed and utilized by similar users, the system can configure the AI agent 100 with relevant knowledge, pre-set actions, and appropriate communication styles. This dynamic assignment and customization are facilitated by the interactions between the AI agent 100, the CMS 102 (and the data it holds), and the knowledge base 110 and the flow of inputs 120.

FIG. 2 shows the architecture of the AI agent according to some embodiments of the invention. This figure shows components and modules for the agent's framework. The agent includes a knowledge portion 202, that is responsible for storing and organizing the information the agent relies on during operation. This includes an internal knowledge base containing data, such as facts used by the agent to make complex decision, or rules which allows the agent to interpret input and make informed choices. Supporting this internal store is a knowledge base management module, which performs storage and retrieval of data. This module can be used to actively governs how the agent accesses the information it needs, when it needs it.

The architecture also provides access to external knowledge sources. This allows the agent to extend its capabilities by incorporating real-time or domain-specific information beyond what is available internally, enhancing the agent's understanding and decision-making processes. To interface with these external sources, the agent is equipped with one or more connectors. These can handle data exchange and communication protocols needed for external access.

The state management component 204 represents another element within the AI agent's architectural design. The state management component 204 oversees how the agent tracks and maintains information about its current and past activities. This includes the state of ongoing tasks and interactions, for ensuring continuity and coherence in its actions and analysis. This component includes both the actual state data and the logic that governs it. By maintaining context over time, the agent is able to perform more intelligently in situations where past actions and ongoing tasks help with future decisions. A dedicated state management module coordinates the use and upkeep of this data. Its role is to ensure that the agent uses state information effectively.

The actions component 206 is the component responsible for controlling and managing the actions that the AI agent performs. This component may correspond to predefined rules and procedures that guide the agent's behavior and ensure that it performs tasks in an orderly and purposeful manner. The actions component 206 may include a database of rules and/or procedures. These rules and procedures define the specific steps that the agent follows when carrying out its actions, providing a structured framework for its behavior. An action management module is included within the actions component 206. This module plays a role in controlling the execution of actions, ensuring that they are performed correctly and in the appropriate sequence. It orchestrates the agent's behavior, guaranteeing that actions are carried out in a logical and organized manner. The actions component 206 may also include one or more connectors. These connectors enable the agent to interact with external applications and tools, allowing it to direct its actions to the appropriate targets and integrate with other systems.

The conversations component 208 allows the AI agent to engage in conversations with external entities. These external entities can take various forms, including human users, software applications, or even other AI agents. The conversations component 208 facilitates communication, enabling the agent to exchange information, pose questions, and provide responses in a natural and intuitive manner. A conversation management module is included within the conversations component 208. This module is responsible for managing the process of engaging in conversations, handling the flow of information to other entities. The conversation component 208 also incorporates a communications interface. This interface serves as the essential bridge, providing the physical or logical connection to the external entities with which the agent interacts. It manages the transmission and reception of messages, enabling the agent to participate fully in conversations and exchange data with the outside world.

The permissions module 210 governs what actions the AI agent is allowed to perform. This component is responsible for controlling what specific actions the agent is authorized to perform and what resources it is allowed to access. It acts as a gatekeeper, ensuring that the agent operates within its designated boundaries. The permissions module 210 comprises a permissions management module. This module is responsible for controlling the way permissions are implemented, ensuring that they are enforced consistently and correctly, and that the agent adheres to the defined rules.

The permissions module 210 also interacts with a permissions database. This database serves as the central repository, holding the permissions data for both the user and the AI agent. The permissions database may reside as an external component, such as an external IAM (Identity and Access Management) or LDAP (Lightweight Directory Access Protocol) component. In such cases, the permissions module 210 includes one or more connectors to engage with these external components, enabling it to retrieve and effectively manage the necessary permissions information.

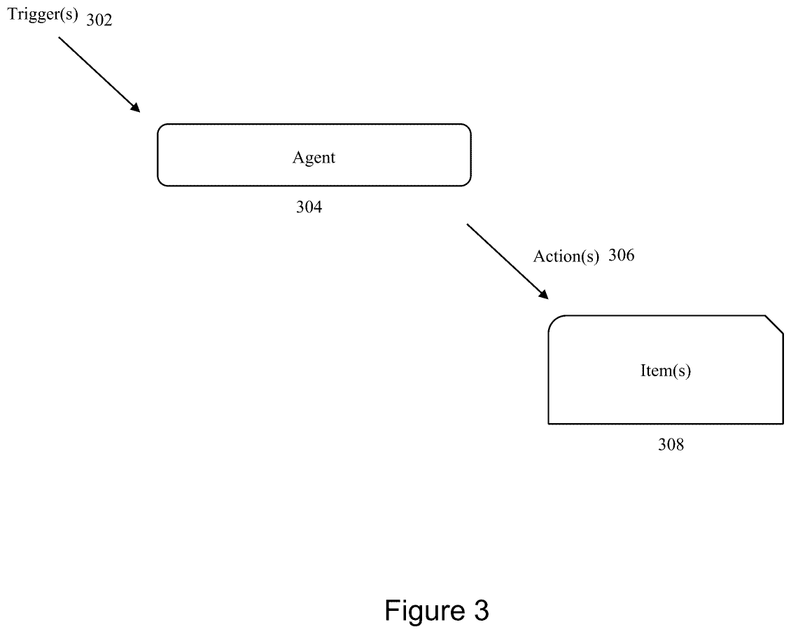

FIG. 3 illustrates the general operational flow of an AI agent within a content management system, according to certain embodiments. Central to this flow is the AI agent 304, which acts both as an intermediary and an active participant in the system's processes. The agent's activities begin upon receiving one or more triggers 302. These triggers initiate the agent's tasks or sequence of actions and can vary widely depending on the specific use case—ranging from user requests to system-generated events or scheduled operations.

Once a trigger 302 is received, the AI agent 304 is capable of performing direct actions 306 on one or more items 308 maintained within the CMS. These items may encompass a broad range of digital assets, including documents, images, videos, and other content types. The nature of the actions taken is tailored to the requirements of the CMS and the user's objectives.

The actions 306 that the AI agent can perform are not limited to simple data manipulation; they encompass a range of operations that enhance user interaction and streamline content management workflows. These actions may include, for example, opening an item for viewing or further processing, providing a preview of an item without fully opening it, and enabling users to modify or update the content of an item.

Furthermore, the AI agent 304 may also facilitate collaborative work by providing actions 306 such as adding collaborators to an item, allowing multiple users to work on the same content simultaneously. The agent may also be capable of deleting an item from the CMS, removing it from the system and freeing up storage space. These examples illustrate the large extent of actions that the AI agent 304 can perform, demonstrating its ability to significantly enhance the functionality of the CMS.

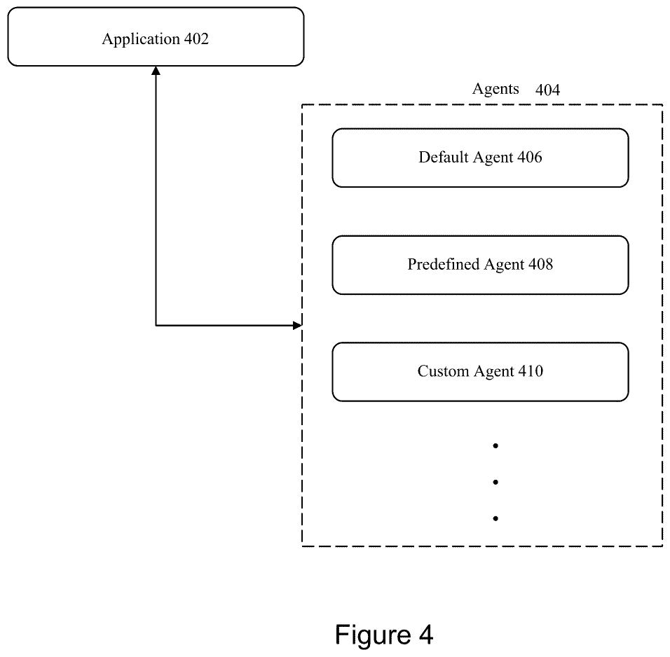

FIG. 4 shows a system architecture where an application 402 plays a significant role in assigning an AI agent 404 to a user. This application serves as the primary interface through which users engage with the system, and it oversees the selection and deployment of the AI agent best suited to each individual's needs. This assignment process is also used for personalizing the user experience and optimizing workflow efficiency within the application.

The system supports a wide variety of AI agent types, each designed with specialized capabilities to address different tasks and workflows. The number of different types of AI agents that can be assigned to a user interacting with the application 402 is substantial and can vary significantly. This variability reflects the wide range of tasks and workflows that users may undertake within the application, and the system's ability to provide them with the most suitable AI support.

Often, users may not have clear insight into which type of AI agent would most effectively support their work. They might be unfamiliar with distinctions among various agent specializations or uncertain how best to use AI assistance for their particular tasks. To address this, some embodiments incorporate an intelligent, automated mechanism that determines the most appropriate AI agent in real time. This mechanism analyzes relevant factors such as the user's current context and active task to dynamically select the AI agent best equipped to assist within the system. Automating this selection simplifies the user experience by removing and/or minimizing the need for manual choice and ensures that users consistently receive the most effective AI support available.

The system architecture supports a wide array of AI agent types, recognizing that different tasks and workflows require different AI capabilities. The specific types of AI agents that can be assigned to a user depend on the nature of the work they are performing within the application 402. This task-specific specialization of AI agents is a key feature of the system, enabling it to provide highly tailored and effective support across a range of activities.

To illustrate this concept, consider the example of a user engaged in the process of making a sale within a business context. This complex workflow involves multiple distinct stages, each of which can benefit from the assistance of a specialized AI agent. The system is designed to recognize these different stages and to assign the appropriate AI agent to each one, ensuring a smooth and efficient sales process.

For instance, a marketing AI agent may be employed to perform marketing activities, which typically occur in the early stages of the sales process. These activities may include sending targeted advertisements to potential customers, engaging in follow-up communications to nurture leads, and analyzing marketing data to optimize campaign effectiveness. The marketing AI agent is specialized in these tasks, enabling it to perform them with a high degree of proficiency.

As the sales process progresses and a potential customer expresses interest, a sales AI agent may be assigned to engage directly with the customer. The sales AI agent is specialized in the art of selling, and it can guide the customer through the sales process, answer their questions, address their concerns, and ultimately facilitate the sale. This agent possesses the knowledge and skills necessary to effectively interact with customers and close deals.

In the later stages of the sales process, a specialized signature AI agent may be utilized to handle the task of processing any sales contract signing that occurs with the customer. This agent can automate the process of generating contracts, ensuring that all necessary information is included, and facilitating the secure and efficient signing of the agreement. The signature AI agent streamlines this important step, reducing the risk of errors and delays.

Finally, once the sale is complete and the necessary documentation has been signed, a storage AI agent may be employed to determine the optimal way to store the sales documentation within the company's database. This agent can analyze the content of the documents, classify them according to predefined categories, and ensure that they are stored in the appropriate location for easy retrieval and future reference. The storage AI agent helps to maintain organized and accessible records, which is essential for efficient business operations.

Beyond task-specific agents, the system also supports different categories of AI agents, providing additional flexibility in how assistance is delivered. Examples of such categories include, for example, default, predefined, and custom agents, each with its own characteristics and use cases.

A default AI agent 406 may be assigned automatically when a user initiates interaction or upon certain system events. This agent offers general-purpose assistance, covering core functionalities that apply across many tasks and workflows, thus providing immediate value while more specialized agents are determined.

Predefined AI agents 408 are configured and optimized for particular workflows or use cases—such as the marketing, sales, and signature agents described earlier. These agents reflect common scenarios and best practices, delivering ready-to-use AI support tailored to typical user needs. The sales process example described earlier, with its marketing AI agent, sales AI agent, and signature AI agent, falls into this category. These predefined agents represent common use cases and best-practice configurations, providing users with readily available AI solutions for their needs.

Lastly, the system allows users or organizations to create custom AI agents 410, designed to meet unique or highly specialized requirements. These agents can be tailored to the specific needs of individual users or organizations, providing a high degree of flexibility and customization. If the existing predefined AI agents do not fully meet a user's requirements, they can create a custom agent with the precise capabilities and functionalities they need. This ability to create custom AI agents ensures that the system can adapt to even the most unique and specialized use cases.

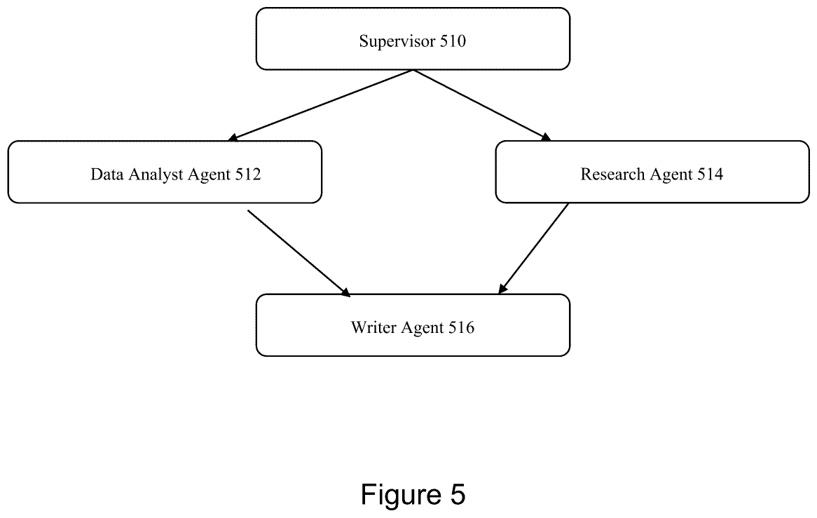

FIG. 5 illustrates a scenario where a supervisor AI agent 510 initiates the creation and coordination of other AI agents to carry out a specific task. In this particular scenario, the supervisor AI agent 510 takes the lead in orchestrating a series of actions, demonstrating the hierarchical capabilities of the AI agent framework and its ability to manage complex workflows through the coordinated efforts of multiple specialized agents.

The process begins when the supervisor AI agent 510 initiates the creation of two distinct AI agents, each with its own area of focus. The first, a data analyst agent 512, is tailored to handle tasks involving data processing, including analysis, interpretation, and the generation of meaningful reports. This agent is equipped to identify trends, draw insights from datasets, and produce summaries that support decision-making.

The supervisor AI agent 510 also creates a research agent 514. This agent is responsible for collecting and synthesizing information from various sources. Designed to navigate and filter large amounts of information efficiently, the research agent 514 compiles findings and delivers concise, relevant knowledge for use by other agents or users.

Once both the data analyst agent 512 and the research agent 514 are operational, they begin interacting with another AI agent, which is the writer agent 516. This interaction highlights the collaborative nature of the AI agent ecosystem, where different agents can work together, leveraging their respective strengths to achieve a common goal. The data analyst agent 512 and the research agent 514 may provide the writer agent 516 with the results of their analysis and research, respectively.

The writer agent 516 is designed to generate written content based on the information it receives. This may include structured reports, summaries, articles, or other documents. By combining research findings and analytical insights, the writer agent 516 is able to produce high-quality, well-informed written materials with minimal human input, streamlining content creation workflows.

The example presented in FIG. 5 illustrates the flexibility and power of the AI agent framework. By using a supervisor agent to delegate tasks to other specialized agents, complex processes can be broken down into manageable parts. Each agent focuses on its area of expertise, and together, they complete the overall objective more efficiently than would be possible with a single agent or manual workflow.

This hierarchical model, with the supervisor AI agent 510 at the top, simplifies task delegation and system maintenance. Because each agent operates independently yet collaboratively, they can be updated, replaced, or reconfigured without disrupting the broader workflow. The ability of agents to initiate and manage other agents greatly enhances the system's scalability and adaptability.

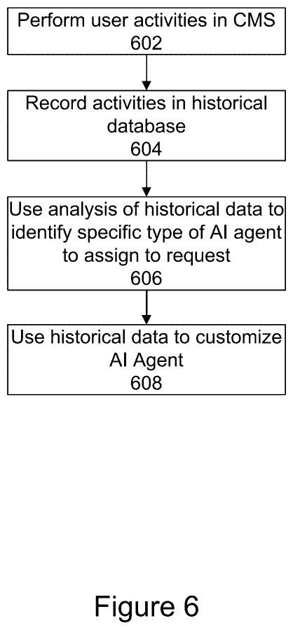

FIG. 6 presents a high-level flowchart depicting the system's method for assigning and customizing AI agents within a content management system (CMS), according to some embodiments of the invention. The steps outlined in this figure reflect how the system intelligently adapts AI assistance to meet individual user needs and support collaborative activities.

The process begins at step 602, where user activities within the CMS are performed. These activities span a wide variety of tasks, such as viewing, editing, creating, or deleting files, and form the basis for understanding how users engage with content. The types of activities captured at this stage offer a detailed picture of the user's interaction with the system. For example, actions may include previewing documents, editing file content, or creating new files.

At 604, the activities may be recorded into a historical database. The system may record, for example, deletions, updates, and other meaningful changes that reflect the user's work habits. Beyond individual content interactions, the system also tracks collaborative behavior. This includes activities such as inviting others to collaborate on a document or assigning editing rights to specific users. These actions provide insight into team dynamics and shared workflows within the CMS. In addition, the system monitors interactions initiated by AI agents. These activities are tracked alongside user interactions, offering a complete view of all system-driven and user-driven activity within the CMS environment.

At step 606, the system analyzes this historical activity data to determine the most suitable AI agent to assign in response to a user request. This decision is based on a combination of factors, including the user's prior behavior, the type of task requested, and patterns observed across similar users. The system maintains a library of predefined AI agents, each designed for specific tasks or workflows. These agents are optimized for performance in areas such as document management, communication, or data analysis, and can be readily assigned to support users as needed.

In step 608, the system further refines the assignment by customizing the selected AI agent to better suit the user's context. This customization process ensures that the agent is not only functionally appropriate but also aligned with the user's working style and access permissions. Customization is informed by the user's historical behavior and system activity. This includes the types of files accessed, typical workflows, and preferred actions. The system also considers the user's access rights, ensuring the agent operates within the authorized boundaries of that user's role.

One key aspect of AI agent customization is based on the characteristics of the individual user. The system analyzes the user's historical activities within the CMS, examining their past interactions with content, their preferred workflows, and their typical tasks. This analysis provides valuable insights into the user's behavior patterns and their specific needs for AI assistance. In addition, the system also takes into account the set of permissions allocated to the user, which defines their access rights to content within the CMS. This information is important for configuring the AI agent's permissions and scope, ensuring that it operates within the boundaries of the user's authorized access.

Beyond the user's individual characteristics, the system also considers data about other entities within the CMS to further refine the AI agent's customization. This approach recognizes that users often work collaboratively and that their activities are influenced by the actions and preferences of their colleagues. By analyzing data about other entities, the system can identify relevant patterns and insights that would not be apparent from looking at the user's data alone.

For example, instead of solely relying on the user's own historical access patterns to determine the type of information that should be accessible by the AI agent, the system also examines the historical access patterns of the user's collaborators and colleagues. This approach allows the system to identify content that is relevant to the user's work but that they may not have accessed themselves in the past. By expanding the scope of the AI agent's access to include this additional content, the system can provide more comprehensive and effective assistance.

To illustrate this point, consider a scenario where a user has historically accessed only content of type A within the CMS. If the system were to customize the AI agent based solely on this user's history, the agent would be configured to access only content of type A. However, this limited scope may prevent the agent from providing the user with all the information they need. It may turn out that the user should also be accessing content of types B and C to effectively perform their work.

By analyzing the historical access patterns of the user's colleagues and collaborators, the system can identify that content types B and C have been accessed by users who are similarly situated to the current user. This insight enables the system to correctly customize the AI agent for the user, granting it access to these additional content types. In contrast, if the system only considered the user's own history, these content types would have been missed, resulting in a less effective and potentially limiting configuration of the AI agent.

Therefore, by looking at the historical data for other entities within the CMS, the system can more accurately and comprehensively customize the AI agent for the user. This approach ensures that the agent has access to all the relevant information it needs to perform its work effectively, taking into account both the user's individual preferences and the broader collaborative context in which they operate.

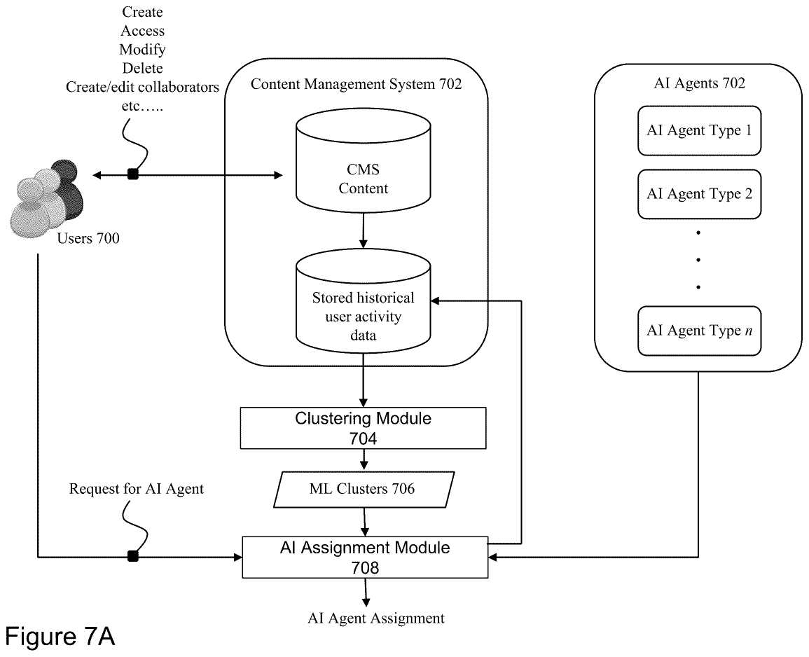

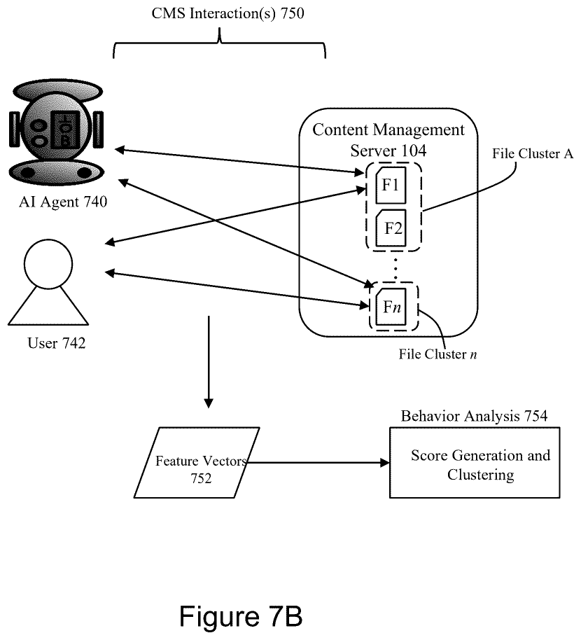

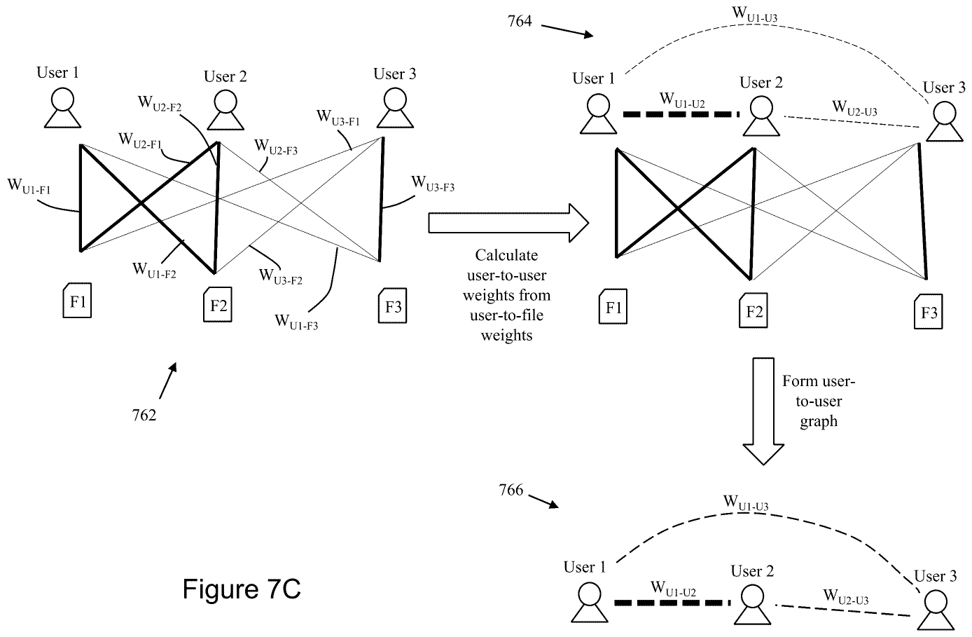

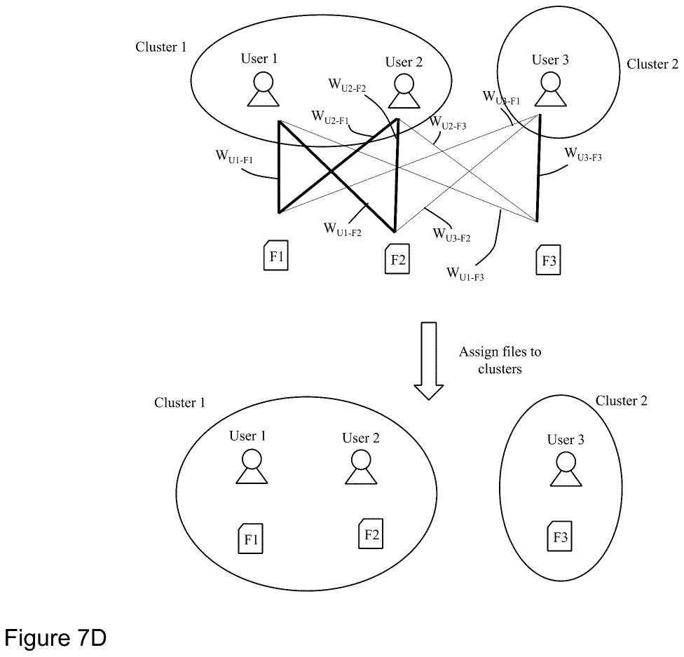

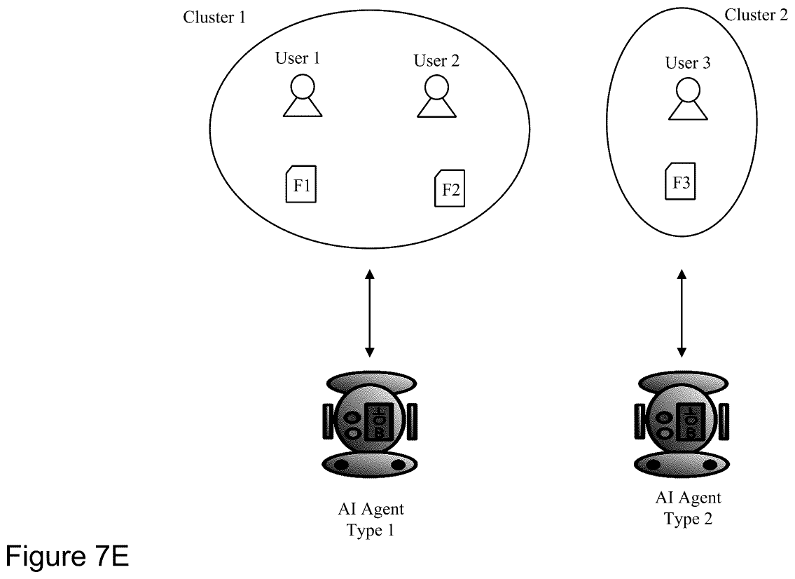

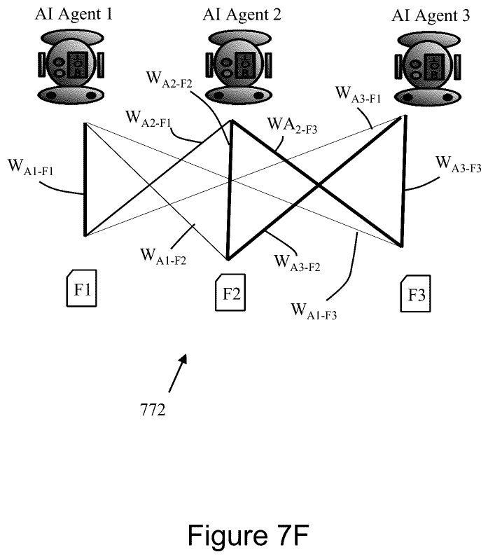

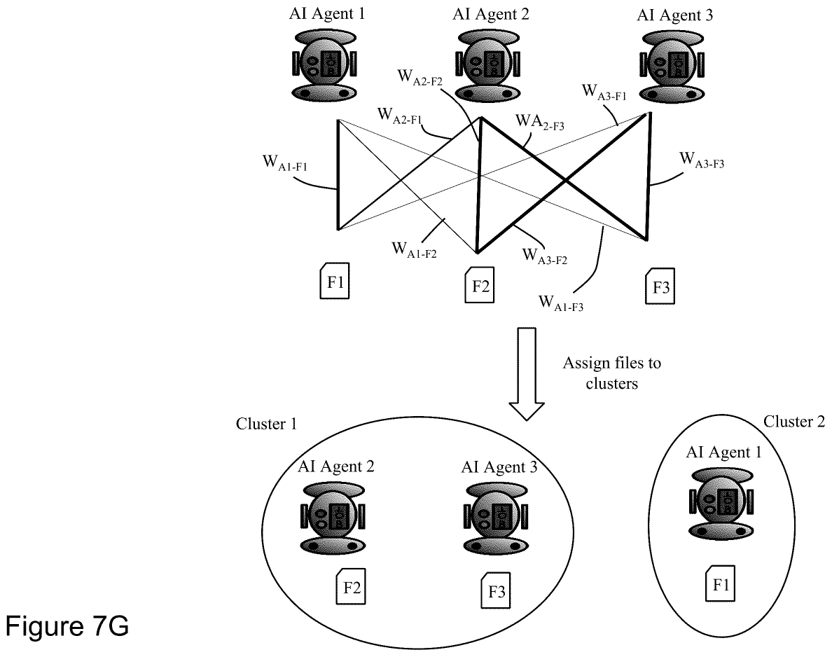

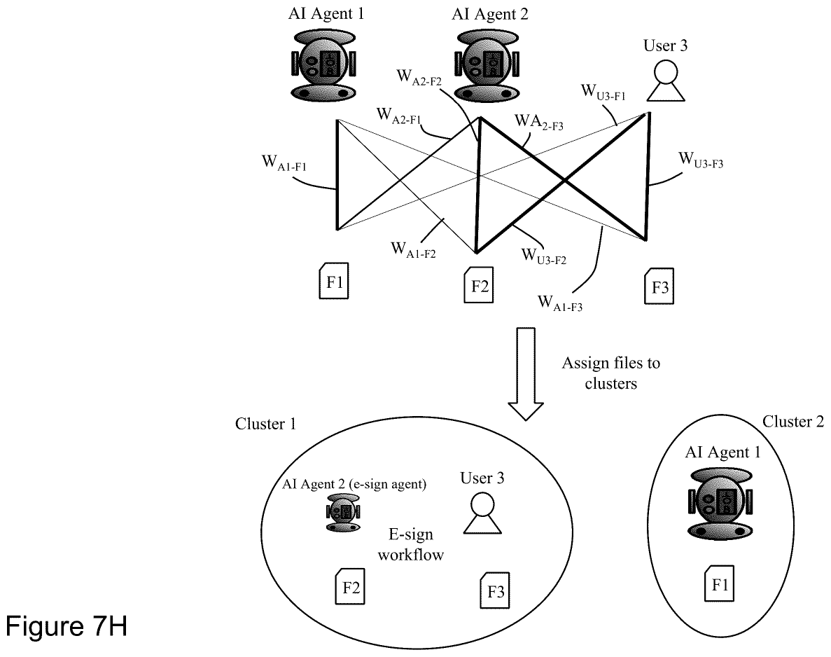

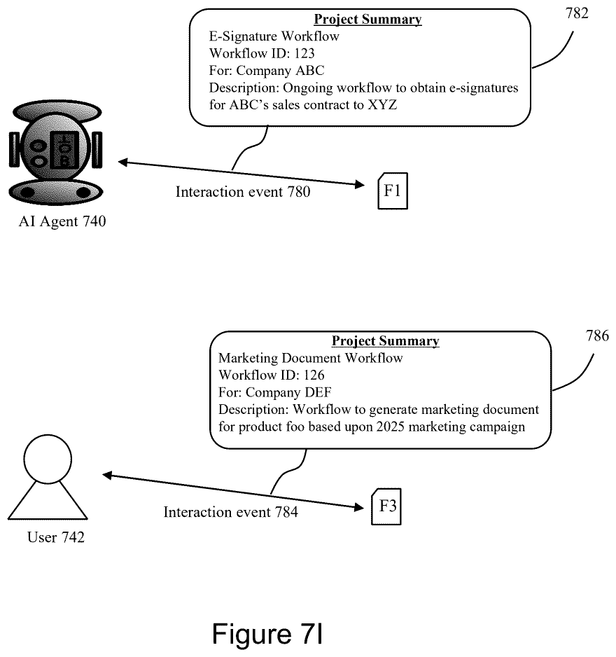

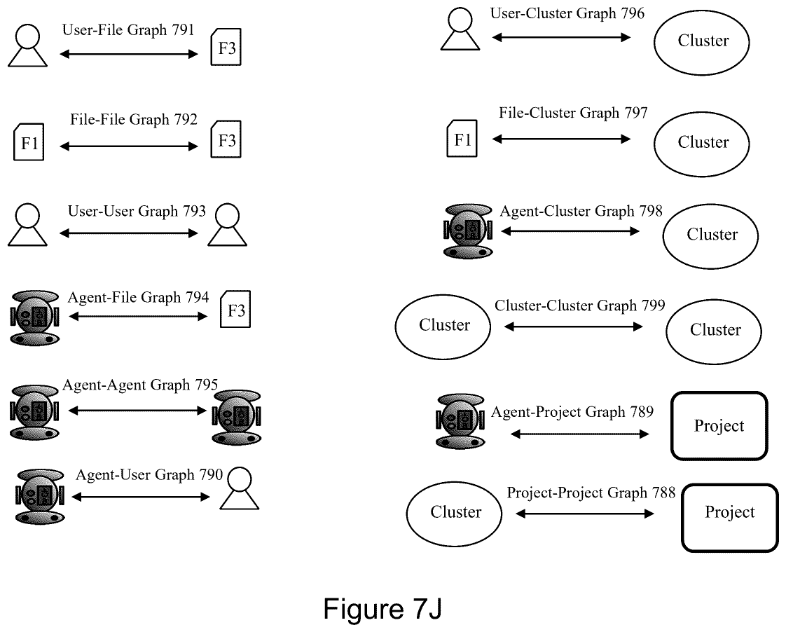

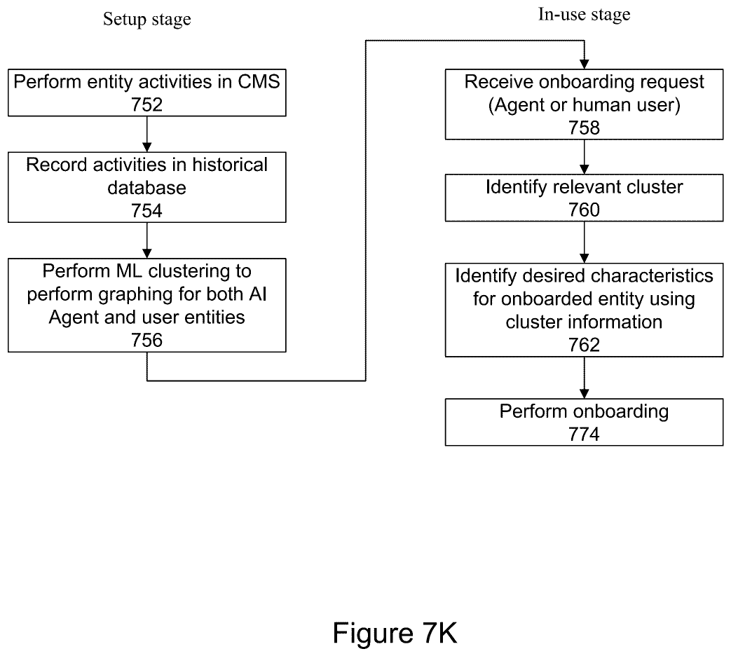

FIG. 7A shows a system architecture designed for the intelligent assignment of AI agents within a content management ecosystem. As illustrated, users 700 interact via a user interface that grants access to digital content managed by a content management system (CMS) 702. The CMS serves as the central repository for storing, organizing, and retrieving a diverse array of digital assets, facilitating collaborative workflows and ensuring the integrity and accessibility of information.

While users engage with the CMS, their activities are captured and recorded as historical data in an associated database. This repository acts as a source of historical information, capturing the patterns of user interactions with the managed content over time. These interactions encompass a wide spectrum of actions, including but not limited to the creation of new content, the deletion or archival of existing assets, the modification and updating of information, the opening and viewing of files, and the rapid assessment of content through preview functionalities.

To extract meaningful patterns from the collected user interaction data, a clustering module 704 is employed. This module is used to implement execution of clustering and analytical techniques over the recorded interactions maintained within the interaction database. One objective of this clustering process is to identify patterns and groupings within the user behavior, thereby detecting portions and groups of users who exhibit similar interaction patterns or preferences with respect to the managed content.

Consequently, the clustering module 704 generates one or more machine learning (ML) clusters 706, each representing a group of users with similar usage habits or content preferences. These clusters organize user behavior into actionable categories, enabling the system to tailor AI support accordingly.

Building on the ML clusters, the system incorporates an AI assignment module 708. This module is responsible for the dynamic and context-aware assignment of AI agents to users based on their specific requests or the context of their current interactions within the CMS 702. The AI assignment module leverages the previously generated ML clusters 706 to intelligently determine the most suitable type of AI agent to provide assistance.

The AI assignment module 708 operates by selecting a specific type of AI agent, represented generically as 710, from a predefined set of available AI agent types. This set, denoted as AI agent types 1, 2, . . . , n, encompasses a diverse range of specialized AI entities, each equipped with unique capabilities and functionalities tailored to address specific user needs or content-related tasks within the content management system. The selection process is driven by the association of user requests or contexts with the previously identified ML clusters.

In certain illustrative embodiments of the invention, the collected interaction data that forms the basis for the clustering analysis specifically pertains to user-to-file interaction data. This granular level of detail allows for a more precise understanding of how individual users engage with specific digital assets within the CMS. For instance, user-to-file interaction data may encompass a rich set of attributes, including the unique identifier of the user (abbreviated as uid), the distinct identifier of the file (abbreviated as fid), the specific type of interaction performed (abbreviated as itype, with non-limiting examples such as create, delete, modify, open, and preview), and the precise timestamp of the interaction (abbreviated as itime).

Furthermore, the system may employ this detailed user-to-file interaction data to generate feature vectors that characterize the behavioral patterns of individual users over defined time periods. These feature vectors serve as quantitative representations of user engagement, enabling the system to compare user behavior across different temporal segments and potentially identify anomalous or evolving patterns of interaction.

In some embodiments, the generation of these feature vectors involves a multi-stage process that begins with the identification of file clusters and the computation of associated weights. Subsequently, these file clusters and weights are utilized to produce the feature vectors that encapsulate the essence of user behavior. The creation of file clusters themselves is a step in this analytical pipeline.

A set of file clusters is constructed to facilitate the generation of the aforementioned feature vectors. Each of these clusters comprises a curated collection of files that have been determined to exhibit a sufficient degree of interrelationship. This relationship signifies that these files are likely to be accessed, utilized, or otherwise interacted with in a similar context or by similar groups of users, thereby warranting their collective analysis.

The methodology employed for generating these file clusters can encompass any suitable analytical approach. One potential and illustrative approach involves the construction of activity graphs. These graphs visually represent the interactions that occur between specific user(s) and specific file(s) within the content management system. In these activity graphs, the users and the files serve as the nodes, while the interactions between them are represented as the edges connecting these nodes.

To further refine the analysis, a weight can be associated with each user-to-file interaction, effectively quantifying the strength or frequency of that particular interaction. The activity graph for a given file can be constructed by systematically identifying all users who have established a connection with that specific file through their interactions. Subsequently, clustering algorithms can be applied to these activity graphs, grouping files into clusters based on the patterns of user engagement.

The assignment of files to user clusters can be guided by the concept of “affinity.” The affinity of a particular file to a specific user cluster is computed as a measure of the strength of the relationships between that file and the users belonging to that cluster. Typically, this affinity is calculated relative to each of the identified user clusters, and the file is ultimately assigned to the cluster that exhibits the highest affinity score for that particular file. This affinity-based assignment ensures that files are grouped with the user segments that demonstrate the strongest historical engagement with them.

FIG. 7B depicts an example approach to implement user-to-file activity graphs, where users 742, AI agents 740, and files (e.g., F1, F2, F3) within a CMS 104 can be represented as nodes, with edges illustrating interactions such as accessing, modifying, or viewing files. Here, CMS interactions 750 may be captured and represented as feature vectors 752, which can then undergo behavioral analysis 754. This analysis of the connections between the various entities and objects can be used to reveal usage relationships between files and users/agents.

The user-to-file activity graphs will represent interactions between various users and/or AI agents and a specific set of files. Within this graphical representation, the individual users, the autonomous AI agents, and the digital files are represented as distinct nodes within the network. The interactions that occur between these entities, such as accessing, modifying, or sharing files, are depicted as edges or connections linking the respective nodes. The construction of such an activity graph can be systematically achieved by, for each file within the content management system, identifying and cataloging all the users who have established a connection to that particular file through any form of interaction. This graph serves as a foundational data structure for subsequent clustering and analysis aimed at discerning relationships between files based on user engagement patterns.

FIG. 7C provides more details regarding the concept of weighted interactions within the activity graph. As depicted in the user-to-file activity graph 762, each interaction or edge connecting a user to a file is associated with a “weight.” In certain embodiments, this weight is quantitatively determined by aggregating the total number of activities, or potentially a specific subset of activity types, that have occurred between a designated user and a particular file. The visual representation in the figure employs varying line thicknesses to intuitively convey the magnitude of these weights. Thicker lines connecting user nodes (e.g., WU1, WU2, WU3) to file nodes (F1, F2, F3) signify higher weights, indicating a greater frequency or intensity of user-to-file activities (e.g., WU1-F1, WU1-F2, WU2-F1, WU2-F2, and WU3-F3). Conversely, thinner lines represent lower weights, suggesting a less frequent or less intense interaction between the connected user and file (e.g., WU1-F3, WU2-F3, WU3-F1, and WU3-F2).

The weights established in the user-to-file activity graph 762 serve as the basis for the derivation of a weighted user-to-user graph, as illustrated by the intermediate representation and the final graph 766. The intermediate representation 764 shows potential weighted links between users (WU1-U2, WU1-U3, WU2-U3), derived from their shared interactions with files. For example, the weight between User 1 and User 2 (WU1-U2) is calculated based on the weights of their individual interactions with the files they both access. The final user-to-user graph 766 is then constructed by collapsing the file nodes and retaining only the user nodes and the weighted edges connecting them. A specific approach for determining these user-to-user weights, in at least one embodiment, involves examining each file shared by a pair of users and adding the smaller of the two file-to-user weights to the corresponding user-to-user link. For instance, the weight WU1-U2 might represent the minimum of the weights associated with User 1's interaction with a common file and User 2's interaction with the same file. The visual depiction in graph 766 uses line thickness to indicate the strength of the user-to-user relationship based on shared file access, with a thick line between User 1 and User 2 suggesting a strong affinity due to their tendency to access the same set of files, while thinner lines for WU1-U3 and WU2-U3 indicate a weaker affinity.

FIG. 7D illustrates the application of clustering algorithms to the derived user-to-user graph 766, resulting in the identification of distinct user clusters. In the depicted example, the clustering process groups User 1 and User 2 into a first cluster, while User 3 is identified as belonging to a second, separate cluster. Various clustering techniques can be employed for this purpose, with Markov clustering being cited as one potential method in certain embodiments. Following the formation of user clusters, the system proceeds to assign the individual files (F1, F2, F3) to these clusters based on a calculated “affinity” score. The affinity of a file to a particular user cluster is determined by summing the weights of the connections between that specific file and all the users who are members of that cluster. The file is then assigned to the user cluster that exhibits the highest affinity score for that file.

In the illustrated scenario, files F1 and F2 are assigned to Cluster 1. This assignment is based on the fact that the aggregate weight of the connections between files F1 and F2 and the users within Cluster 1 (Users 1 and 2, represented by the thicker lines indicating higher interaction weights such as WU1-F1, WU1-F2, WU2-F1, WU2-F2) significantly exceeds the aggregate weight of their connections to User 3 in Cluster 2 (represented by the thinner lines indicating lower interaction weights such as WU3-F1 and WU3-F2). Conversely, file F3 is assigned to Cluster 2. This is because the high weight of the connection between file F3 and User 3 in Cluster 2 (WU3-F3, represented by a thick line) is substantially greater than the aggregate weight of its connections to Users 1 and 2 in Cluster 1 (WU1-F3 and WU2-F3, represented by thinner lines). Ultimately, the file clusters are defined by the specific files contained within each user-centric cluster. In this example, File Cluster 1 comprises files F1 and F2, while File Cluster 2 contains file F3.

FIG. 7E shows where the previously established user and content clusters can be used to determine and assign the most appropriate type of AI agent to a user interacting with the content management system. This figure underscores how the characteristics of a user's current activity, the specific content they are engaging with, and their affiliation with a particular behavioral cluster collectively inform the selection of an AI agent best suited to enhance their productivity and experience. The diagram conceptually maps the identified clusters to distinct types of AI agents, thereby creating a framework for personalized and task-optimized AI support.

The central concept illustrated in FIG. 7E is the association between the derived clusters and the available AI agent types. The system maintains a catalog of AI agents, each possessing a unique set of skills, knowledge domains, and functionalities tailored to address specific needs within the content management environment. These AI agents might specialize in tasks such as content summarization, intelligent search and retrieval, automated metadata tagging, workflow optimization, collaborative assistance, anomaly detection, or various other functions.

The assignment process is based at least in part on the identification of the cluster to which a particular user and/or the specific content they intend to access or interact with is associated. This association can be determined in real-time based on the user's current context, their historical behavioral patterns that led to their inclusion in a specific cluster, and the characteristics of the content itself, which may have been categorized into a particular file cluster based on usage patterns.

The figure presents a conditional logic: if a specific combination of a user and/or the content they are about to access is found to be associated with a designated “first cluster,” and if this “first cluster” has been configured or dynamically linked to a particular “first type of AI agent,” then the system will automatically assign this “first type of AI agent” to the user. This direct mapping ensures that users belonging to a specific behavioral segment, or those interacting with content exhibiting usage patterns indicative of a particular cluster, receive AI assistance that has been deemed most effective for users and content within that grouping.

Similarly, the figure illustrates a parallel scenario: if the combination of the user and/or the content falls under the purview of a “second cluster,” and if this “second cluster” has been associated with a distinct “second type of AI agent,” then this “second type of AI agent” will be the one assigned to the user. This demonstrates the system's ability to differentiate between various user and content contexts and to deploy a diverse array of AI agents, each optimized for the specific needs and patterns identified within its corresponding cluster.

The underlying mechanism for establishing these associations between clusters and AI agent types can involve various machine learning techniques, expert system rules, or a combination thereof. For instance, through offline analysis of historical user interactions and the effectiveness of different AI agents in various contexts, the system can learn which AI agent types yield the best outcomes for users belonging to specific clusters or interacting with content from particular file clusters. This learning process can continuously refine the cluster-to-agent mappings, ensuring that the AI assistance provided becomes increasingly relevant and beneficial over time.

The dynamic nature of this assignment process is a key advantage. As users navigate the content management system and interact with different types of content, the system continuously evaluates their context and their potential cluster affiliations. Based on this real-time assessment, the most appropriate AI agent is invoked to provide timely and relevant support. This eliminates the need for users to manually select an AI agent or to possess prior knowledge of which agent might be most helpful for their current task.

Furthermore, the cluster-based assignment strategy allows for a more efficient utilization of AI resources. Instead of deploying a generic AI agent that may not be optimally suited for every user or every task, the system intelligently directs specialized AI agents to the contexts where they are most likely to provide significant value. This targeted deployment enhances the overall effectiveness of the AI integration within the content management system, leading to improved user satisfaction and increased productivity.

The associations between clusters and AI agent types can also be configured and customized by system administrators to align with specific organizational needs and workflows. For example, certain clusters of users who frequently collaborate on specific types of documents might be associated with an AI agent that specializes in facilitating real-time co-editing and version control. Similarly, users who predominantly engage in content review processes might be assigned an AI agent that excels at identifying inconsistencies or suggesting editorial improvements.

In essence, FIG. 7E encapsulates the intelligent orchestration of AI assistance within the content management system. By leveraging the insights gained from clustering user behavior and content usage patterns, the system can dynamically assign the most relevant AI agent to a user based on their current context, thereby transforming the interaction with digital assets into a more intuitive, efficient, and productive experience. This cluster-driven approach to AI agent assignment represents a significant advancement over traditional, static methods of AI integration, paving the way for truly personalized and contextually aware AI support in content management environments.

FIG. 7F extends the scope of the inventive system by highlighting the recognition that the interactions recorded within the content management system are not solely limited to those initiated by human users. Instead, the system can capture and/or analyze interactions that are also performed by the AI agents themselves. This acknowledgment of AI agents as active participants within the system's ecosystem opens up a new dimension for understanding system dynamics, optimizing AI agent collaborations, and potentially identifying areas for further enhancement of the AI agent framework. The figure underscores the potential to apply the same analytical techniques, such as graph construction and clustering, to the interaction patterns of the AI agents.

The central insight presented in FIG. 7F is that the detailed logs of activities within the CMS provide a comprehensive record of all actions performed, regardless of whether the initiator is a human user or an AI agent. This includes actions such as AI agents accessing, modifying, creating, deleting, or sharing content, as well as their interactions with various system components and potentially with each other. By treating AI agent activities as integral data points, the system gains a holistic view of the information flow and operational dynamics within the content management environment.

Building upon this comprehensive data collection, the embodiments of the invention, as illustrated in FIG. 7F, can generate specialized graphs that specifically represent AI-to-file interactions. Similar to the user-to-file interaction graphs described in earlier figures, these AI-to-file graphs depict the relationships between individual AI agents (acting as nodes) and the digital files they interact with (also represented as nodes). The edges connecting these nodes signify specific interactions performed by the AI agents on the files, and these edges can also be associated with weights that reflect the frequency, type, or intensity of the AI agent's engagement with the content.

The construction of AI-to-file interaction graphs enables a deeper understanding of the roles and behaviors of individual AI agents within the system. By analyzing the patterns of file access and modification by different AI agents, it becomes possible to discern their primary responsibilities, their areas of expertise, and their contributions to the overall content management workflows. This information can be invaluable for monitoring the performance of AI agents, identifying potential bottlenecks in AI-driven processes, and ensuring that AI agents are operating effectively and as intended.

Furthermore, FIG. 7F introduces the concept of leveraging the AI-to-file interaction data to derive higher-level relationship graphs, such as AI-to-AI interaction graphs or AI-to-cluster graphs. AI-to-AI interaction graphs would depict the direct communication or collaborative activities between different AI agents within the system. The nodes in such a graph would represent individual AI agents, and the edges would signify instances where one AI agent interacts with or relies upon the output of another AI agent. The weights associated with these edges could reflect the frequency or the importance of these inter-agent dependencies. Understanding these collaborative relationships can be important for optimizing multi-agent workflows and ensuring seamless coordination between different AI functionalities.

Alternatively, or in conjunction with AI-to-AI graphs, the system can construct AI-to-cluster graphs. In this type of graph, the nodes would represent individual AI agents and the previously identified user or file clusters. The edges connecting AI agents to clusters would indicate the extent to which a particular AI agent interacts with or is relevant to the users or content within that specific cluster. The weights on these edges could signify the frequency or the nature of the AI agent's involvement with the cluster, providing insights into the AI agent's domain of influence or specialization.

The analysis of these AI-centric graphs, whether AI-to-file, AI-to-AI, or AI-to-cluster, can yield valuable insights for system optimization and future development. For instance, identifying AI agents that frequently interact with each other might suggest opportunities for streamlining their communication protocols or even merging their functionalities. Similarly, analyzing which AI agents are most active within specific user or file clusters can inform the refinement of AI agent assignment strategies, ensuring that the most relevant AI assistance is consistently provided to the appropriate user segments and content areas.

Moreover, tracking the evolution of AI agent interaction patterns over time can help in identifying potential anomalies or unintended behaviors. Deviations from established interaction patterns might indicate a malfunction in an AI agent or an unforeseen consequence of a system update. By continuously monitoring these AI-driven interactions, the system can proactively detect and address potential issues, ensuring the stability and reliability of the AI agent framework.

In essence, FIG. 7F underscores the importance of treating AI agents as integral actors within the content management system and extending the analytical lens to encompass their interactions. By constructing and analyzing AI-centric graphs, the inventive system can gain a deeper understanding of the complex interplay between users, content, and AI agents, paving the way for more intelligent system design, optimized AI agent collaboration, and ultimately, a more efficient and user-centric content management experience. This holistic approach to system monitoring and analysis, encompassing both human and artificial interactions, represents a significant step towards truly intelligent and adaptive content management solutions.

FIG. 7G illustrates the application of clustering algorithms to a derived Agent-to-Agent graph, resulting in the identification of distinct AI Agent clusters. In the depicted example, the clustering process will cluster AI Agent 2 and AI Agent 3 into a first cluster, while AI Agent 1 is identified as belonging to a second, separate cluster. Following the formation of the clusters, the system proceeds to assign the individual files (F1, F2, F3) to these clusters based on a calculated affinity score. The affinity of a file to a particular cluster is determined by summing the weights of the connections between that specific file and all the Agents who are members of that cluster. The file is then assigned to the user cluster that exhibits the highest affinity score for that file.

FIG. 7H illustrates the concept of a combined graph that includes both user-to-file interactions as well as AI Agent-to-file interactions. This extends the scope of the inventive system by highlighting the recognition that the interactions recorded within the content management system may exist with respect to multiple different types of entities that act upon a common set of content (e.g., files). Using the weights of the interactions, this means that the above-described clustering approach may be used to generate clusters that include multiple types of entities within the same cluster. In the current example, the clustering will associate AI Agent 2 and User 3 with a first cluster, while AI Agent 1 is identified as belonging to a second, separate cluster. The system may also assign the individual files (F1, F2, F3) to these clusters based on a calculated affinity score.

It is noted that the clustering approach may user additional information to characterize the relationship of the entities and objects for that cluster. For example, the type of interactions associated with the entities for the cluster may be further characterized and associated with the cluster. In the example shown in this figure, it can be seen that cluster 1 is specifically associated with an e-sign workflow, and that the AI agent 2 associated with the cluster is a specialized AI agent to perform e-signature tasks. This information may be derived from signals associated with the type of interactions that are used to construct the graphs (e.g., where the graphed interactions provide information regarding the specific type of actions or workflow task performed by the entities on a content object). Or, as described in more detail below, project information may be used to associated a cluster and/or its associated entities/objects with information such as specific workflow corresponding to the cluster.

As shown in FIG. 7I, each interaction may be associated with additional information regarding the interaction that may be used by the system to perform the clustering and analysis processing. A “project summary” may be generated that is associated with some aspect of the interaction. For example, a project summary may be associated with the entity that performs the interaction, associated with the subject of the interaction (e.g., file), and/or associated with the interaction itself.

Each interaction comprises a set of information that is associated with some aspect of the interaction. For example, a LLM may be used to analyze the context, scope, and/or parameters over a large number of interactions to summarize one or more specific projects that have occurred or are currently occurring within the system. The LLM will then compress the large amount of information associated with a given project into a brief summary. Examples of information that may be provided in a project summary may include, for example, a project name, project date(s), project entities, project workflow(s) or workflow stage(s), tools used by the project, specific information sources used by the project, summary of activities for the project, etc.

In the example illustrated in FIG. 7I, AI Agent 740 has engaged in an interaction event 780 with file F1. The interaction event 780 may be associated with specific interaction event data such as interaction type, date, filename, etc. A project summary 782 is associated with any of the participants or objects of the interaction, or even associated with the interaction itself. Similarly, User 742 has engaged in an interaction event 784 with file F3. The interaction event 780 may be associated with specific interaction event data such as interaction type, date, filename, etc. A project summary 786 is associated with any of the participants or objects of the interaction 784.

The project summary maybe used in conjunction with any vectors/embeddings associated with the interactions to help process the circumstance for clustering and AI agent assignments. As just one example, workflow information within the project summary may be used to associate specific types of AI agents with identified clusters. For instance, the project summary may be used to help identify an AI agent that is specialized to handle e-signature projects, so that this type of agent will be assigned to future e-signature projects. As another example, user/enterprise/customer information within the project summary may be used to associate specific types of AI agents with identified users or enterprises. For instance, the project summary may be used to help identify an AI agent that corresponds to Company ABC, so that this type of agent will be assigned to future projects for users from Company ABC, versus perhaps another AI Agent that is specific to another company.

Therefore, it is evident that multiple types of relationship graphs may be used within the system. As shown in FIG. 7J, the system may generate user-to-file graphs 791, file-to-file graphs 792, and user-to-user graphs 793. In addition, the system may also generate graphs that include AI Agents. For example, the system may generate Agent-to-file graphs 794, Agent-to-Agent graphs 795, and Agent-to-user graphs 790. With respect to identified clusters, the system may generate user-to-cluster graphs 796, file-to-cluster graphs 797, Agent-to-cluster graphs 798, cluster-to-cluster graphs 799, or cluster-to-project graphs 788. The graphs may be directed to projects as well. For example, as shown in the figure, the system may generate Agent-to-project graphs 789, or any other project-related graphs such as user-to-project, or file-to-project graphs.

The graphs may be used for any useful purpose to which such graphs may be employed. For example, as shown in FIG. 7K, one possible use-case is to use the graphs for the onboarding of an entity in the content management system. A new entity to be onboarded usually needs numerous types of configuration settings to be applied for that entity. For example, the entity may need settings to be configured to allow the entity to be able to access specific content within the CMS, as well as the specific level(s) of access to be permitted for that content. When the new entity is being onboarded, it may not be an easy exercise to determine the exact set of configurations that should be applied or that new entity. However, the inventive graphing of embodiments of the invention may be used to render the onboarding process both more efficient and more accurate, improving the ability of the onboarded entity to be able to immediately perform expected workloads without undue constraints, while still maintaining high levels of security in the system.

During a setup stage, the process begins at step 752, where activities are performed within the CMS by users, AI agents, or any other types of entities that may be operating within or with respect to the CMS. These activities may encompass a wide range of actions that are performed as interactions occur with the system and its content. As the entity engages with the CMS, the system records these activities, capturing valuable data about their behavior and interactions at 754. The types of user activities recorded at step 754 may involve any interaction activities with the CMS. These activities include actions such as opening a file to view or edit its content, previewing a file to quickly assess its contents without fully opening it, creating a new file to add content to the system, modifying an existing file to update its information, and deleting a file to remove it from the system. In addition to recording interactions with individual files, the system also tracks their activities in relation to other entities within the CMS. This includes capturing actions such as the user adding another user as a collaborator to an existing file, enabling them to work together on the same content, or assigning another user as an editor to a file, granting them the ability to modify its content. Furthermore, the interaction activities recorded at step 754 also include interactions initiated by one or more AI agents within the system. These AI agent interactions are recorded alongside user activities.

At 754, ML-based clustering analysis is performed using the interaction data. As noted above, the clustering analysis may be used to generate graphs pertaining to any type of entity within the system, including both AI agents and human users.

During an in-use phase, a request may be received to onboard an entity within the CMS. The onboarding request may pertain to any type of entity, such as a human user or an AI agent. The onboarding request may be for any type of situation for which onboarding may be implemented. For example, one type of onboarding is when a human user is newly hired onto a team and thus needs the appropriate configurations settings for a new user in that situation. Another example of an onboarding situation is when an AI agent is newly assigned to work on a project or workflow task, and thus needs the appropriate configurations for that new AI agent assignment.

At 760, the appropriate cluster is identified for the entity to be onboarded. It is noted that the cluster may include either or both human users and/or AI agents that are associated with that cluster. Since the onboarded entity may be either an AI agent or a human user, this means that the entity to be onboarded may be of the same or different type of entity within the cluster, or with respect to a mixed cluster having multiple types of entities. For example, an AI agent may be onboarded based upon a cluster comprising AI agents, human users, or a mixture of both AI agents and human users. Similarly, human user may be onboarded based upon a cluster comprising AI agents, human users, or a mixture of both AI agents and human users.

At 762, the characteristics of entities within the cluster are used to identify the configuration settings that should be applied to the onboarded entity. For example, if other members of that cluster all need to have access to a given folder with both read and write permissions, then it is likely that a newly onboarded entity that corresponds to the cluster will also need configuration settings to have those same access permissions to the same content. These settings would be applied to the new entity by the CMS at 774.

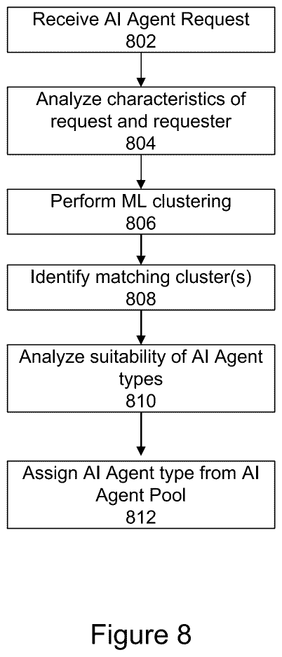

FIG. 8 presents a detailed flowchart that outlines the steps involved in the intelligent assignment of an AI agent to a user request, according to certain illustrative embodiments of the present invention. This flowchart provides a granular view of the decision-making process undertaken by the system to ensure that users receive the most appropriate and contextually relevant AI assistance tailored to their specific needs and the nature of their request within the content management ecosystem. The process begin at 802, where the system actively receives a request from a user seeking the assistance or functionality provided by an AI agent. This request can originate from various interaction points within the content management system's user interface or through programmatic interfaces.

Upon the receipt of an AI agent request at step 802, the system proceeds to an analytical phase, depicted by step 804. At this stage, a comprehensive analysis is performed, reviewing the inherent characteristics of the received request as well as the attributes and historical behavior of the user or entity making the request (the requester). This in-depth assessment involves examining the specific nature of the task or query articulated in the request, the context within which the request is made (e.g., the specific content being accessed or manipulated, the user's current workflow), and relevant information pertaining to the requester. This user-specific information may encompass their role within the system, their assigned permissions and access privileges, their historical interaction patterns with the content management system, and their previously established preferences or settings.

Following the detailed analysis of the request and the requester at step 804, the system advances to step 806, where a machine learning (ML) clustering process is performed. This step leverages the vast repository of historical user interaction data, potentially including the characteristics of past requests and the attributes of the users who submitted them. The clustering algorithms, operating on this historical data, aim to identify inherent groupings or segments of users and requests that exhibit statistically significant similarities in their attributes and patterns. This clustering process effectively categorizes users and their requests into distinct behavioral cohorts or contextual groupings based on shared characteristics and interaction histories.

The output of the ML clustering performed at step 806 is then utilized in the subsequent step, 808, where the system undertakes the task of identifying the most relevant matching clusters for the current, newly received request. By comparing the characteristics of the present request and the attributes of the requesting user with the defining features of the previously established clusters, the system aims to pinpoint one or more clusters that exhibit the highest degree of similarity or relevance to the current context. This matching process may involve employing various similarity metrics and pattern recognition techniques to accurately align the current request with the appropriate historical groupings.

Once the relevant matching clusters have been identified at step 808, the system proceeds to step 810, where a detailed analysis of the different types of AI agents available within the system's AI agent pool is conducted. This analysis focuses on evaluating the suitability of each AI agent type with respect to the characteristics and requirements associated with the identified matching cluster(s). Each AI agent type possesses a unique set of capabilities, functionalities, knowledge domains, and interaction styles. The system assesses how well the specific skills and attributes of each AI agent type align with the typical needs and patterns of users and requests belonging to the identified cluster(s). This suitability analysis may involve considering factors such as the AI agent's expertise in handling tasks similar to the current request, its proficiency in interacting with the type of content involved, and its historical effectiveness in assisting users within the identified behavioral segments.

Based on the comprehensive suitability analysis performed at step 810, the system proceeds to the final step in this detailed flowchart, step 812. At this stage, the system makes a decisive selection of the most appropriate AI agent type from the available AI agent pool. This selection is driven by the outcome of the suitability analysis, prioritizing the AI agent type that best aligns with the characteristics of the current request and the identified matching cluster(s). Once the optimal AI agent type has been determined, an instance of an AI agent of that selected type is instantiated or drawn from the AI agent pool and subsequently assigned to the user who initiated the request. This assignment ensures that the user receives AI assistance that is highly tailored to their specific needs, the context of their request, and the collective intelligence gleaned from the historical behavior of similar users and requests. This intelligent and dynamic assignment process aims to maximize the effectiveness and utility of AI agent integration within the content management system, ultimately enhancing user productivity and overall system experience.

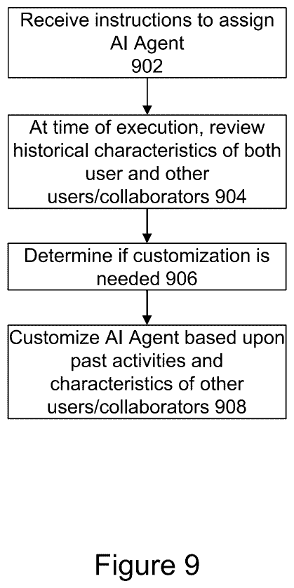

FIG. 9 presents a high-level flowchart that outlines the steps involved in a dynamic approach to customize an AI agent, ensuring that the assistance provided is finely tuned to the specific context of the user and the broader environment within the content management system. This customization process is not a static configuration but rather an adaptive mechanism that occurs at the point of the AI agent's operation, allowing for a highly personalized and effective interaction. The flowchart commences at step 902, where the system receives instructions to assign an AI agent to a particular user or in response to a specific trigger within the system. This instruction could be initiated by a direct user request, an automated system process based on user activity, or the outcome of an intelligent agent assignment module as described in previous figures.

Following the initial instruction to assign an AI agent at step 902, the system proceeds to a contextual review phase, depicted by step 904. Significantly, this review of information is strategically performed at the time of execution for the AI agent, ensuring that the customization is based on the most current and relevant data. During this phase, the system examines a comprehensive set of information pertaining to both the requesting user and other pertinent entities within the content management system's ecosystem. The information related to the user may encompass their individual characteristics, such as their role, permissions, historical interaction patterns, preferred settings, current task context, and even their affiliation with specific user clusters identified through behavioral analysis.

Concurrently, the system also reviews information concerning other relevant entities within the system at step 904. These entities can include a diverse range of elements that might influence the optimal behavior and configuration of the AI agent. This may involve analyzing the specific content the user is interacting with, the metadata associated with that content, the collaborative context (e.g., other users involved in the same workflow or accessing the same content), the prevailing system state, and even the characteristics and recent activities of other AI agents that might be interacting with the same user or content. This holistic view of the user and the surrounding system environment at the point of execution is critical for informed customization.

Upon the completion of this information review at step 904, the system advances to a decision-making step, represented by 906, where a determination is made regarding whether customization of the AI agent is necessary or beneficial for the current context. This determination can be based on a set of predefined rules, dynamic thresholds, or machine learning models that evaluate the degree to which the default configuration of the selected AI agent aligns with the specific characteristics of the user and the other entities within the system. For instance, if the user's profile and the context of their interaction closely match a pre-optimized configuration for the assigned AI agent type, customization might be deemed minimal or unnecessary. Conversely, significant deviations or unique contextual factors would trigger the customization process.

If the determination at step 906 indicates a need for customization, the system proceeds to step 908, where the AI agent undergoes a dynamic adaptation process. This customization is intelligently driven by the comprehensive information gathered in step 904, taking into account both the user's own unique characteristics and the relevant information pertaining to other entities within the system. The customization process can involve adjusting various parameters and configurations of the AI agent. This might include tailoring the AI agent's knowledge base to emphasize information relevant to the user's role or current task, pre-selecting specific actions or functionalities that are likely to be most useful in the given context, adapting the AI agent's communication style to match the user's preferences or the tone of the current interaction, and even fine-tuning the AI agent's access permissions to align with the user's privileges and the sensitivity of the content being accessed.

The fact that the AI agent is customized based not only on the user's individual attributes but also on information regarding other entities within the system underscores the collaborative and context-aware nature of this customization approach. For example, if the user is collaborating with a specific group of colleagues on a document, the AI agent might be customized to prioritize information or functionalities that facilitate team collaboration. Similarly, if the content being accessed has specific security classifications or metadata tags, the AI agent's behavior and access patterns might be adjusted accordingly to ensure compliance and data integrity. This holistic customization ensures that the AI agent operates not in isolation but as an intelligent and integrated component of the broader content management ecosystem, providing assistance that is truly relevant and optimized for the specific circumstances of the user and their interactions within the system.

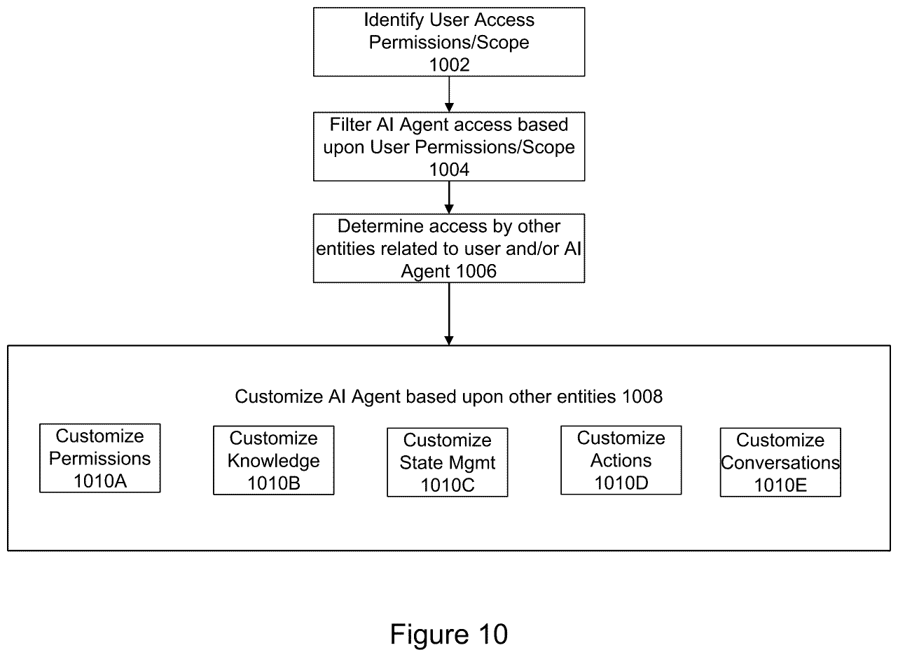

FIG. 10 presents a more granular and detailed flowchart that elaborates on the intricate steps involved in a context-aware approach to customizing an AI agent at its execution time, ensuring that its capabilities and behavior are precisely aligned with the user's authorized scope and the collective intelligence derived from the historical interactions of other relevant entities within the content management system. This detailed process underscores the system's commitment to providing secure, relevant, and optimized AI assistance by dynamically adapting the AI agent's internal structure and functionalities based on a confluence of factors.

The customization process commences at step 1002, where the system reviews the access permissions and scope of the user who has invoked or been assigned the AI agent. This involves a thorough examination of the user's authorized boundaries within the content management system, including the specific content, functionalities, and resources they are permitted to access and interact with. This step establishes the fundamental constraints within which the AI agent must operate on behalf of the user.

Following the review of the user's access permissions and scope at step 1002, the system proceeds to step 1004, where a filtering process is applied to the AI agent's potential access to system resources. This filtering is directly informed by the user's established permissions and scope. For instance, as explicitly illustrated in the example provided, if a user's access is strictly limited to content residing within a specific folder, designated as “folder A,” then the AI agent's ability to access content residing in other folders within the content management system is effectively filtered out and restricted. This ensures that the AI agent, while acting on the user's behalf, operates strictly within the confines of the user's authorized domain, preventing any unauthorized access to sensitive or restricted information. This security-centric filtering mechanism is paramount in maintaining data integrity and adhering to established access control policies within the system.

Having established the boundaries of the AI agent's access based on the user's permissions, the system then moves to step 1006, where the historical interaction records of other relevant entities within the system are reviewed. These “other entities” can encompass a broad range of elements, including other users who have interacted with the same content or within similar contexts, other AI agents that have previously assisted users in related tasks, or even the content items themselves and their historical usage patterns. The purpose of this review is to glean insights into effective strategies, relevant knowledge, common workflows, and potential preferences that have been observed in similar scenarios. By analyzing these historical records, the system aims to identify patterns and contextual cues that can inform the customization of the AI agent for the current user and their specific task.

The insights derived from the historical data review of other entities at step 1006 directly feed into the AI agent customization process, as depicted in step 1008. At this stage, the AI agent undergoes a dynamic adaptation of its internal structure and functionalities based on the learned patterns and contextual information. The flowchart further illustrates that this customization can impact various internal components of the AI agent, referencing the architectural elements detailed in FIG. 2. Specifically, the examples provided (collectively labeled 1010) highlight several key areas of the AI agent that may be subject to customization upon execution.

These customizable components include permissions customization (1010A), where the specific actions the AI agent is authorized to perform, within the user's overall scope, can be further refined based on historical usage patterns in similar contexts. Knowledge customization (1010B) involves tailoring the AI agent's internal knowledge base to prioritize information that has been frequently accessed or proven relevant in past interactions related to the current user's task or the content they are engaging with. State customization for the agent (1010C) allows for the pre-configuration or adjustment of the AI agent's internal state variables based on the typical progression of similar tasks undertaken by other users. Actions customizations (1010D) involve adapting the set of actions the AI agent can readily invoke or suggest to the user, based on the actions that have historically been most effective in comparable scenarios. Finally, conversations customizations (1010E) entail adjusting the AI agent's communication style, the types of questions it asks, or the format of its responses to align with patterns observed in successful past interactions with users in similar contexts.

By dynamically customizing these internal aspects of the AI agent based on both the user's access permissions and the collective intelligence derived from the historical data of other relevant entities, the system ensures that the AI assistance provided is not only secure and within the user's authorized scope but also highly relevant, contextually appropriate, and optimized for the specific task at hand. This detailed customization process at the point of execution represents a sophisticated approach to delivering truly intelligent and user-centric AI support within the content management system. Each of the example customizations for these categories are described below.

Permissions customization involves dynamically adjusting the specific actions the AI agent is authorized to perform on behalf of the user, within the boundaries of the user's overarching access rights. This fine-grained control ensures that the AI agent operates with the least privilege necessary for the task, enhancing security and preventing unintended actions. If a user has permission to both “view” and “comment” on documents within a project folder, but historical data for similar tasks (e.g., initial document review by junior team members) shows that users in this context primarily utilize the “view” and “highlight” functionalities provided by an AI agent, the permissions customization might temporarily restrict the AI agent's ability to initiate “comment” actions during this initial phase. This focuses the AI agent's capabilities on the most relevant actions for the immediate task, reducing potential for accidental or premature collaboration features. Once the user progresses in their workflow (e.g., moves to a feedback stage), the AI agent's permissions could be dynamically expanded to include commenting functionalities.

Knowledge customization entails tailoring the AI agent's internal knowledge base to emphasize information, concepts, and data that are most pertinent to the user's current task, the content they are interacting with, and the patterns observed in historical interactions of other entities in similar contexts. This ensures the AI agent provides relevant and focused information, avoiding overwhelming the user with extraneous details. For example, if user is working on a sales proposal document related to a specific product line (“Product X”), the knowledge customization might prioritize information about Product X within the AI agent's knowledge base. This could involve pre-loading relevant FAQs, marketing materials, technical specifications, and past successful proposal sections related to Product X. Furthermore, if historical data shows that users working on similar proposals frequently inquire about competitor analysis for Product X, the AI agent's knowledge might be augmented with readily accessible competitive intelligence data. This proactive knowledge loading ensures the AI agent is primed to answer likely user questions and provide relevant suggestions without requiring explicit user queries.

State customization involves pre-configuring or adjusting the AI agent's internal state variables based on the typical progression and common states observed in historical workflows related to the user's current task. This allows the AI agent to anticipate the user's needs based on the stage of their work and maintain a contextually appropriate understanding of the interaction. For example, if a user initiates a document review workflow, historical data might indicate that users in this stage typically begin by summarizing the document's key findings, followed by identifying areas needing improvement. The state customization for the AI agent could pre-load a “summarization mode” or proactively suggest summarization tools upon initiation of the review. As the user progresses and starts highlighting specific sections, the AI agent's state could transition to a “feedback analysis mode,” prompting suggestions for common feedback categories or providing tools for tracking revisions. This stateful awareness allows the AI agent to offer timely and contextually relevant assistance as the user moves through their workflow. As another example, the state customization component may customize the length of time that some given content is locally maintained in the state data for the AI agent. Based upon the user's own historical needs, perhaps certain content may be held for x days. However, based upon historical needs by collaborators or other related users, customization may be applied to retain that state for x+n number of days instead.

Actions customizations involve adapting the set of actions the AI agent can readily invoke, suggest, or automate for the user, based on the actions that have historically been most frequently or effectively utilized by other entities in similar contexts. This streamlines the user experience by presenting the most relevant functionalities upfront. For example, if a user frequently collaborates on documents within a specific team, historical data might show that AI agents assisting users in this team often utilize actions like “suggest collaborator,” “initiate co-editing session,” or “share with team channel.” The actions customization for an AI agent assigned to this user in a collaborative document editing scenario might prioritize these team-centric actions within its interface or proactively suggest them based on the user's activity. Conversely, if the user is working on a solo task, actions related to individual content manipulation (e.g., “reformat text,” “check grammar”) might be prioritized. As another example, the actions module may include access for first set of external tools for access by the AI agent based upon only the user's own history. However, when considering the historical data for other users, customization may be applied to provide access for a second (and possibly more expansive or more limited) set of external tools for be accessed by the agent.

Conversations customizations entail adjusting the AI agent's communication style, the types of questions it asks, the level of detail in its responses, and the overall flow of the interaction to align with patterns observed in successful past interactions with users in similar contexts or with similar communication preferences. This aims to create a more natural, efficient, and user-friendly dialogue. For example, if historical data indicates that a particular user persona (e.g., a technical expert) prefers concise and direct answers with minimal introductory remarks, the conversations customization for an AI agent interacting with such a user might prioritize brevity and technical accuracy in its responses. It might also be less likely to engage in lengthy pleasantries. Conversely, if another user persona (e.g., a new user) tends to benefit from more detailed explanations and step-by-step guidance, the AI agent's conversational style might be adjusted to provide more comprehensive answers and proactive prompts for clarification. The AI agent might also be customized to ask more open-ended questions to guide the new user through a process.

This portion of the disclosure will now address embodiments of approaches to address prompt injection and other malicious threats involving AI.

As previously discussed, prompts may serve as a way for bad actors to introduce malicious actions or security threats within a system. The bad actor may use prompt injection to introduce a security vulnerability, where an attacker manipulates an AI's behavior by inserting malicious instructions into a prompt, tricking the model into ignoring its original safeguards. The prompt injection attaches may be direct or indirect. Indirect prompt injection attacks are where malicious commands are hidden in external sources like websites or documents that the AI is asked to analyze. In these cases, a user might unknowingly trigger a security breach simply by asking the AI to summarize a corrupted webpage.

Current strategies for handling prompt injections focus on “defense-in-depth,” which involves layering multiple security controls rather than relying on a single fix. The most common approach is the use of automated guardrails, where secondary AI models scan incoming text for malicious patterns or malicious intent before the primary model ever sees it. Developers also employ structural techniques like delimiters to clearly mark user data and follow the principle of least privilege, ensuring that even if an AI is compromised, it lacks the technical permissions to perform high-risk actions like deleting files or accessing private databases without human intervention. The fundamental limitation of these approaches is that LLMs are designed to be fluid and helpful, making them inherently susceptible to linguistic manipulation. Unlike traditional software that uses strict syntax, LLMs cannot perfectly distinguish between a legitimate instruction and a malicious one hidden in a clever metaphor or a different language. Consequently, security becomes a cat-and-mouse game, whereas guardrails become more sophisticated, attackers find new ways to bypass them using new techniques or encoding malicious commands in ways that safety filters do not currently recognize.

Embodiments of the present invention provide an improved approach to address these types of attacks. The system analyzes the historical activities within the CMS, examining past interactions by AI with regards to previous content, workflows, prompts, and/or actions. The system can consider data about these topics with regards to any other entities and/or objects within the CMS to refine the historical. By analyzing this type of data, the system can identify relevant patterns and insights in either a supervised and/or unsupervised manner that allows for identification of possible malicious activity involving AI entities.

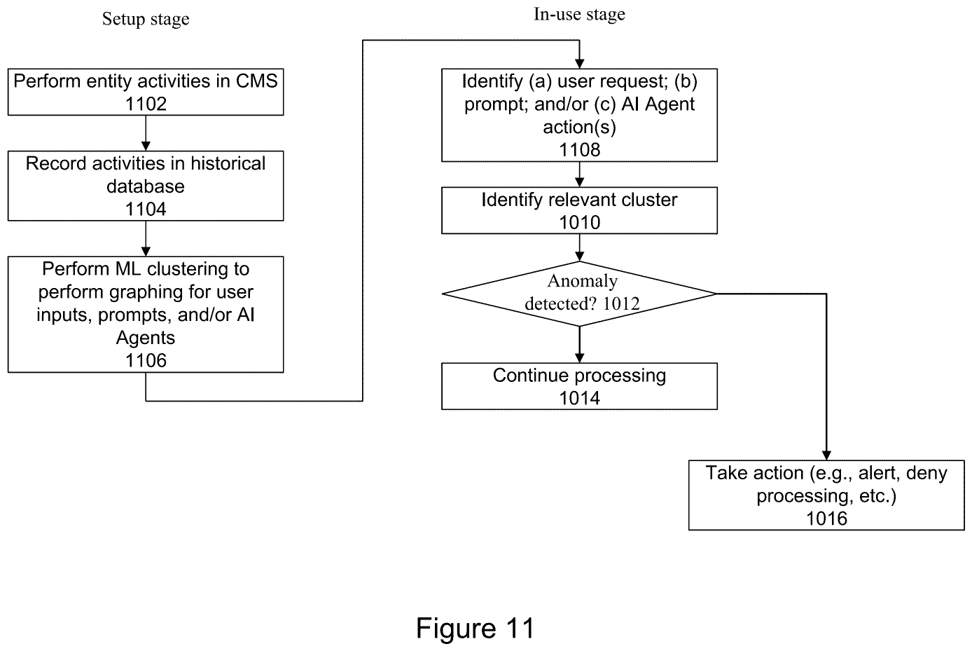

FIG. 11 shows a flowchart to implement some embodiments of the invention. During a setup phase, the process begins at step 1102, where activities are performed within the content management system (CMS) by one or more entities, including human users, AI agents, and/or other automated or semi-automated components operating within or in association with the CMS. These activities may occur during routine operation of the system and may span content access, content manipulation, workflow execution, and AI-assisted interactions. The setup phase may occur continuously or periodically as the system is in operation, thereby enabling accumulation of historical activity data over time.

As interactions occur, the system records activity data at step 1104, capturing information representative of behavioral characteristics and interaction patterns associated with the entities operating within the CMS. The recorded activities may include interactions with content objects such as opening files for viewing or editing, previewing files, creating new files, modifying existing files, deleting files, moving files, or changing access permissions. The activity data may further include metadata associated with such interactions, including timestamps, frequency of access, sequence of actions, execution context, and identity attributes of the entities performing the activities.

In addition to content-level interactions, the system records activities associated with interactions between entities within the CMS. This includes interactions involving AI agents, such as AI-initiated actions, AI-generated content, AI-to-AI communications, and AI-assisted workflows triggered on behalf of human users. The recorded data may further capture relationships between entities and objects, including which users or AI agents accessed particular content items, the manner in which such access occurred, and whether the access was direct, delegated, or autonomously initiated by an AI agent.

Furthermore, the activity data recorded at step 1104 includes information associated with prompts involved in the interactions. Such prompt-related information may include prompts generated by human users, prompts generated or modified by AI agents, contextual data provided alongside prompts, actions related to the prompts, execution outcomes associated with the prompts, and/or behaviors associated with the prompts that may relate to any of the previous items over a time period. In some embodiments, the system records prompt structure, semantic attributes, embedded instructions, and relationships between prompts and resulting actions within the CMS. This prompt-related historical data enables subsequent behavioral modeling and clustering analysis to identify normal versus anomalous prompt usage patterns involving AI entities.

At step 1106, the system performs machine learning-based clustering analysis on the recorded interaction data collected at step 1104. The clustering analysis is configured to identify behavioral groupings and relationships among entities, actions, prompts, and content objects within the CMS. The interaction data may be preprocessed prior to clustering, including normalization, feature extraction, embedding generation, dimensionality reduction, and temporal segmentation, to facilitate accurate identification of meaningful behavioral patterns.

In some embodiments, the clustering analysis generates one or more behavioral models or graphs representing historical activity within the CMS. Nodes of such graphs may correspond to entities (e.g., human users, AI agents, system components), content objects (e.g., files, folders, datasets), prompts, or actions, while edges represent relationships or interactions between nodes, such as access events, execution sequences, or prompt-to-action correlations. The clustering process may group nodes or subgraphs based on similarity metrics derived from interaction frequency, semantic similarity of prompts, action sequences, execution context, or temporal characteristics.

The clustering analysis may be performed using supervised, unsupervised, or semi-supervised learning techniques. In unsupervised embodiments, clusters are formed without pre-labeled data, allowing the system to autonomously discover baseline behavioral patterns for AI agents and users. In supervised embodiments, historical data labeled as benign or malicious may be used to train models to recognize known categories of behavior. In semi-supervised embodiments, limited labeled data may be combined with larger volumes of unlabeled interaction data to improve clustering accuracy and adaptability over time.

In certain implementations, clustering is performed across multiple dimensions of activity, including prompt characteristics, entity identity, action type, content sensitivity, and execution outcomes. For example, prompts may be clustered based on semantic embeddings, structural attributes, or instruction patterns, while AI agent behaviors may be clustered based on action sequences, scope of access, or deviation from prior operational norms. These multi-dimensional clusters enable the system to correlate prompt usage with downstream effects, thereby capturing complex behavioral relationships that are not detectable through single-factor analysis.

The resulting clusters and associated characteristics may be stored as reference models representing expected or historical behavior within the CMS. These reference models may be updated dynamically as additional interaction data is collected, allowing the clustering analysis to adapt to evolving system usage patterns while preserving historical baselines. In some embodiments, cluster confidence scores, boundaries, or statistical distributions are maintained to support subsequent anomaly detection operations. The clusters generated at step 1106 are subsequently used during the operational phase to evaluate new interactions, prompts, or AI-initiated actions for potential anomalous or malicious behavior.

During an operational or in-use phase, at step 1108, the system identifies an interaction operation that is intended to perform an activity within the content management system (CMS). The interaction operation may be initiated by a human user, an AI agent, or another automated entity operating within or in association with the CMS. The identification of the interaction operation may occur prior to execution of the operation, during execution, or immediately following execution, depending on system configuration and enforcement requirements.

In some embodiments, the interaction operation corresponds to a work request or task request, such as a request to access, modify, generate, summarize, analyze, or otherwise process content stored within the CMS. The operation may involve a workflow execution, a content transformation, a data retrieval request, or a system-level action. The operation may further involve the invocation of an AI model, such as a large language model (LLM), to perform natural language processing or decision-making functions in connection with the requested activity.

In other embodiments, the interaction operation corresponds to a prompt that is generated, issued, or modified as part of an interaction with an AI model. The prompt may be authored directly by a human user, generated autonomously by an AI agent, or derived from a combination of user input and system-provided context. The prompt may include instructions, constraints, contextual information, or embedded data references, and may be intended to cause the AI model to perform one or more actions within the CMS. In some cases, the prompt may originate from external content, such as a document or web resource, that is provided to the AI model for analysis.

In further embodiments, the interaction operation corresponds to an action or activity performed autonomously by an AI agent without an explicit contemporaneous user request. Such actions may include executing a scheduled workflow, performing background content analysis, initiating communications with other AI agents, or modifying content or metadata within the CMS. The system identifies these AI-initiated operations in a manner similar to user-initiated operations, thereby enabling consistent monitoring and analysis of interactions regardless of their source.

For each identified interaction operation, the system may extract and associate relevant contextual information, including the identity of the initiating entity, the target content or objects, the sequence of actions involved, the associated prompt or prompts, and the execution context. This contextual information enables subsequent analysis to determine whether the interaction operation conforms to established behavioral patterns or exhibits characteristics indicative of anomalous or potentially malicious activity involving AI prompts or actions.

At step 1110, the system identifies one or more relevant clusters corresponding to the interaction operation identified at step 1108. The identification of the relevant cluster is based on a comparison between characteristics of the interaction operation and the behavioral patterns represented by the clusters generated during the clustering analysis. The relevant cluster represents a set of historically observed behaviors that are determined to be most similar to the current operation based on one or more similarity metrics.

Each identified cluster may be associated with a defined set of characteristics that describe expected behavior within the CMS. Such characteristics may include, for example, attributes associated with entities (such as human users, AI agents, or system components), objects (such as files, folders, data records, or workflows), actions (such as read, write, delete, generate, or execute operations), and prompts (such as prompt structure, semantic intent, or contextual references). In some embodiments, the system maps the interaction operation to multiple clusters, each representing a different behavioral dimension, such as entity behavior, prompt behavior, or action sequencing.

At step 1012, the system determines whether an anomaly is detected by evaluating the interaction operation against the characteristics of the identified cluster or clusters. This determination may involve assessing whether one or more aspects of the operation fall outside statistical bounds, confidence thresholds, or similarity ranges associated with the cluster. An anomaly may be detected when the operation deviates from established behavioral baselines, including deviations in prompt content, action sequences, access patterns, timing, frequency, or relationships between entities and content objects.

In some embodiments, the anomaly determination incorporates anomaly scoring, risk weighting, or confidence estimation to quantify the degree of deviation from expected behavior. The system may consider contextual factors such as historical behavior of the initiating entity, sensitivity of the targeted content, prior anomaly detections, or known attack signatures. An anomaly may be identified even if individual components of the operation appear benign in isolation, but collectively exhibit a pattern indicative of potential prompt injection, privilege escalation, or other malicious AI-driven behavior.

If an anomaly is detected, processing proceeds to step 1016, at which one or more responsive actions are performed to address the detected anomaly. Such actions may include generating an alert or notification to a system administrator, security service, or monitoring interface; restricting, suspending, or blocking execution of the interaction operation; requiring additional authentication or human approval; modifying the operation to enforce additional constraints; or invoking enhanced logging and monitoring procedures. The selected action may depend on the severity of the anomaly, system policy, or operational context.

If no anomaly is detected at step 1012, processing proceeds to step 1014, where the interaction operation is allowed to execute or continue execution in a normal manner. In such cases, the system may optionally update historical activity data to reflect the completed operation, thereby enabling continuous refinement of the behavioral clusters and baselines over time. This adaptive feedback mechanism allows the system to distinguish between legitimate behavioral evolution and genuinely anomalous activity involving AI prompts or actions.

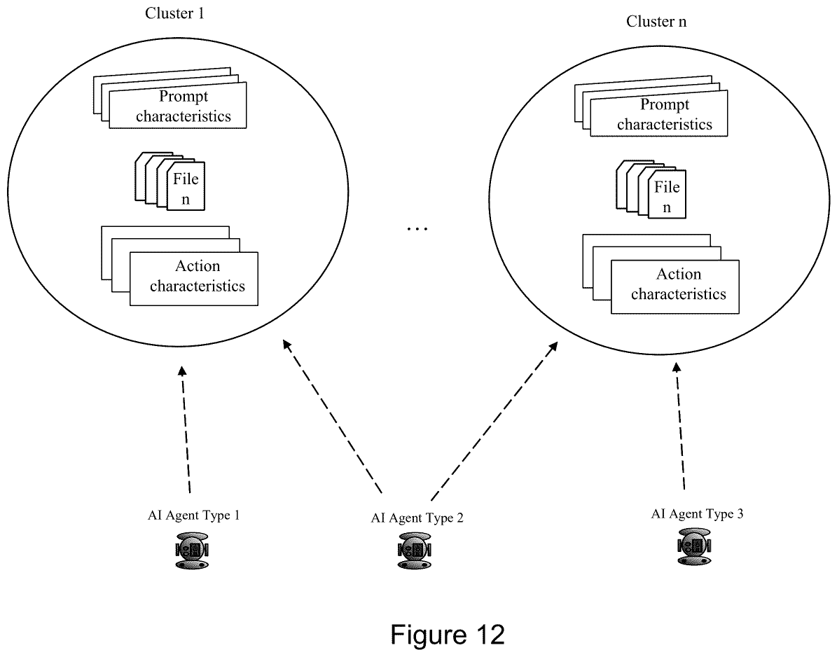

FIG. 12 visually depicts an example clustering model used by the system to associate interaction characteristics with one or more AI agent types. As illustrated, multiple clusters are derived from historical interaction data and may each include a combination of prompt characteristics, content object characteristics (e.g., files), and action characteristics. These clusters represent distinct behavioral patterns observed within the system. The figure conceptually illustrates how different clusters correspond to different types of AI agents, such that the characteristics of a given interaction—whether involving a prompt, a content object, or an action—may be associated with one or more behavioral clusters linked to a particular AI agent type.

The central principle illustrated in FIG. 12 is the association between derived behavioral clusters and AI agent types maintained by the system. The system maintains a plurality of AI agents, each having a defined set of capabilities, permissions, knowledge domains, and operational characteristics. These AI agent types may be specialized for particular functions within the content management environment, such as content summarization, intelligent search and retrieval, automated metadata extraction, workflow assistance, collaborative support, or anomaly detection. By associating clusters with specific AI agent types, the system is able to determine which types of agents are typically involved in, or appropriate for, interactions exhibiting certain combinations of prompt characteristics, content characteristics, and action characteristics.

It is noted that other types of clustering may be implemented according to alternative embodiments of the invention. For example, prompts may be clustered with actions, files, users, etc. Therefore, the specific type of clustering shown in this figure is illustrative, and the portion of the figure shown as “AI Agent types” may be replaced with other criteria for clustering.

In the illustrated embodiment, each cluster aggregates interaction features that commonly occur together, such as particular prompt structures, semantic attributes, referenced files, and resulting actions. For example, a first cluster may correspond to interactions involving summarization-type prompts applied to document files and resulting in read-only actions, while another cluster may correspond to workflow-oriented prompts that trigger multi-step actions across multiple content objects. These clusters may be generated using the machine learning-based clustering techniques described above and may be updated over time as additional interaction data is collected.

The association between clusters and AI agent types enables context-aware analysis of AI behavior, including detection of anomalous or potentially malicious activity. When an AI agent generates or executes a prompt or action that maps to a cluster typically associated with a different AI agent type, or that does not align with any established cluster, the system may identify the interaction as anomalous. In the context of prompt injection detection, such misalignment may indicate that a prompt has been manipulated to cause an AI agent to behave outside its expected operational scope. Accordingly, FIG. 12 illustrates how clustering of prompt, content, and action characteristics provides a structural basis for identifying deviations from normal AI behavior and enforcing appropriate safeguards within the system.

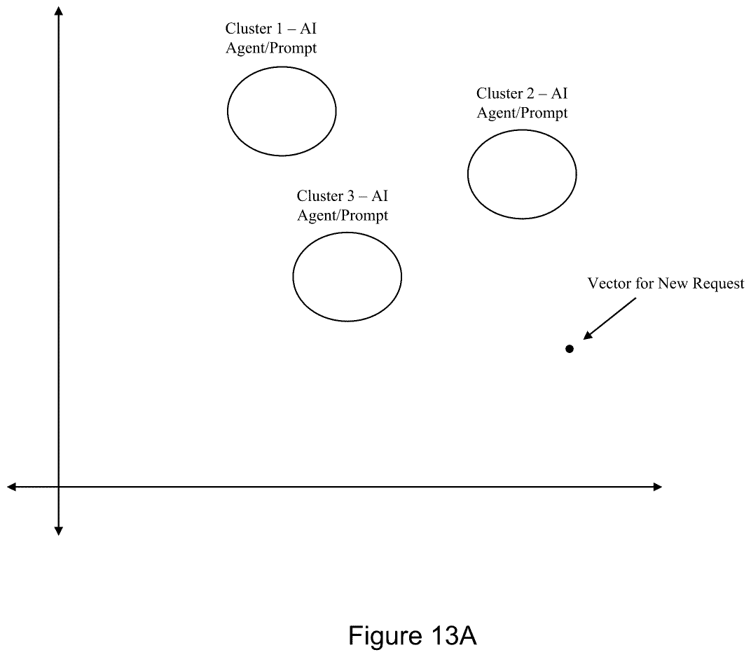

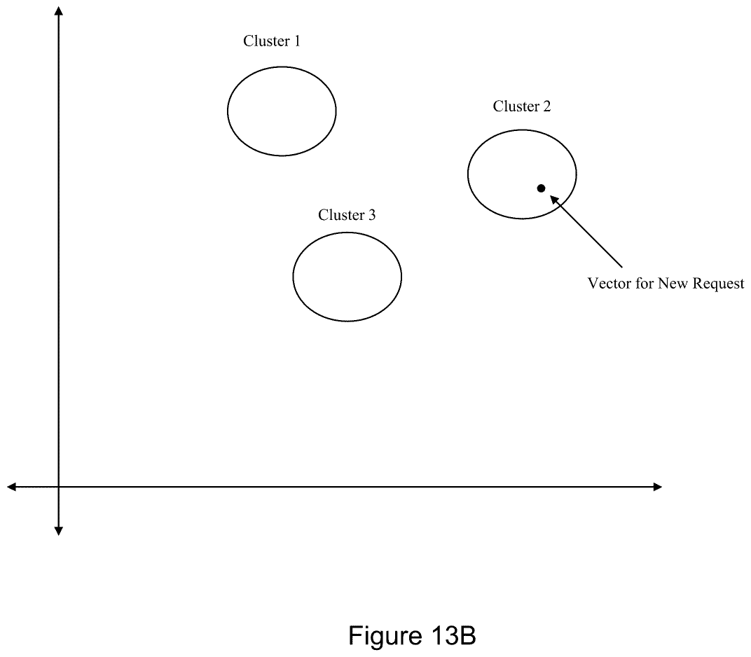

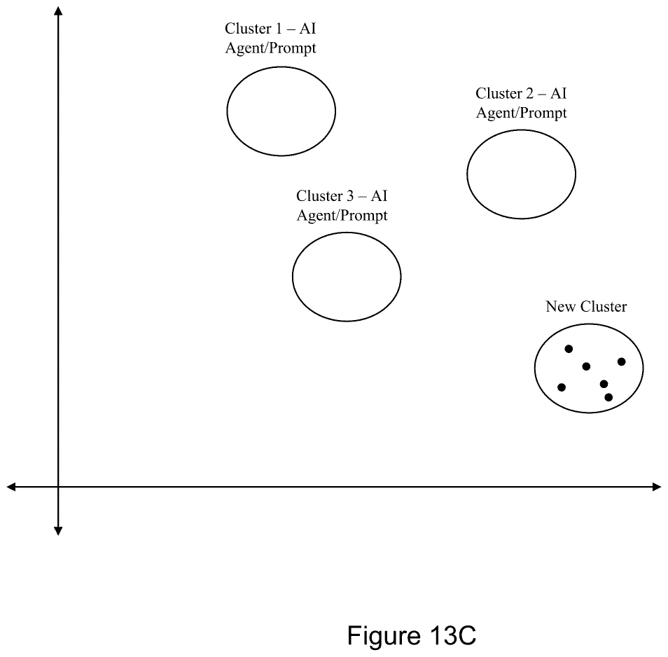

As shown in FIG. 13A, the system maintains a plurality of machine learning (ML)-derived clusters corresponding to historical activities previously observed within the system. Each cluster represents a grouping of past interactions that share similar characteristics, including prompt-related attributes, AI agent involvement, action sequences, and contextual features. In the illustrated example, clusters 1, 2, and 3 are shown, each corresponding to a distinct set of historical behaviors associated with known and previously observed prompts and interactions.

When a new request is received by the system, the characteristics of the request are extracted and transformed into a vectorized representation. The vectorized characteristics may include semantic features of the prompt, structural attributes of the prompt, contextual information associated with the request, identity or type of the initiating entity, and any intended or inferred actions associated with the request. This vector representation enables the system to compare the new request against the historically derived clusters in a uniform feature space.

As further illustrated in FIG. 13A, if the vector corresponding to the new request does not sufficiently correspond to, or fall within, any of the historically tracked ML clusters, the system determines that the request exhibits anomalous behavior. Such non-alignment may indicate that the request deviates from established behavioral patterns, including patterns associated with legitimate prompt usage. In response to detecting this anomaly, the system may generate an alert or notification to provide a heads-up regarding a potential security threat, such as a prompt injection attempt or other malicious manipulation intended to alter AI behavior.

FIG. 13B illustrates a contrasting scenario in which the vector corresponding to the new request falls within the bounds of one of the existing historical clusters. In this example, the characteristics of the new request are determined to be consistent with previously observed and expected behavior patterns represented by the cluster. As a result, the request is not identified as anomalous, and no alert is generated. This comparison between FIGS. 13A and 13B demonstrates how the system differentiates between anomalous and non-anomalous AI prompt interactions based on alignment with historical ML-derived clusters.

FIG. 13C illustrates how unsupervised machine learning can be used improve the process of identifying anomalies. Unsupervised machine learning provides an approach to organize unlabeled, raw input data into groups based on inherent similarities, without prior training on target labels. In this process, algorithms such as K-Means, hierarchical, or density-based clustering treat data points as vectors in a multidimensional space and measure their proximity using metrics like Euclidean distance. As the algorithm iterates, it identifies dense regions where new or existing vectors clump together, iteratively refining these groups—or centroids—until it defines natural clusters that distinguish high-density, similar data points from outliers or other groups. This approach therefore allows the model to discover hidden patterns, segment data, and identify new and meaningful groupings that were not previously apparent in the original dataset. As shown in FIG. 13C, the previously identified anomaly vectors may, over time, form a new cluster of prompt characteristics. Once these new clusters form, then the system will be able to recognize and learn about new “normal” behaviors. Therefore, the system is capable of itself learning and identifying consistent patterns within what was previously flagged as anomalous, and implements an adaptive framework that incorporate this new cluster into the “normal” profile. This prevents the system from triggering redundant false alarms for these known patterns, allowing it to focus on truly novel, unclassified deviations

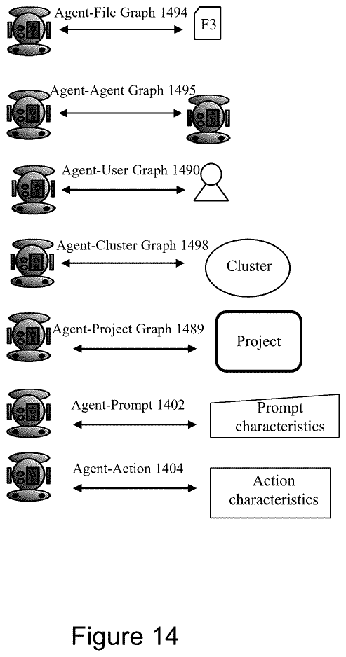

FIGS. 14, 15, 16, and 17 provides illustrative examples of relationship graphs that may be used within the system to implement this functionality.

As shown in FIG. 14, the system may generate relationship graphs between AI agents and various other entities or objects within the system. These include, for example, agent-to-file graphs 1494, Agent-to-Agent graphs 1495, Agent-to-user graphs 1490, agent-to-cluster graphs 1498, agent-to-project graphs 1489, agent-to-prompt graphs 1402, and/or agent-to-action 1404 graphs.

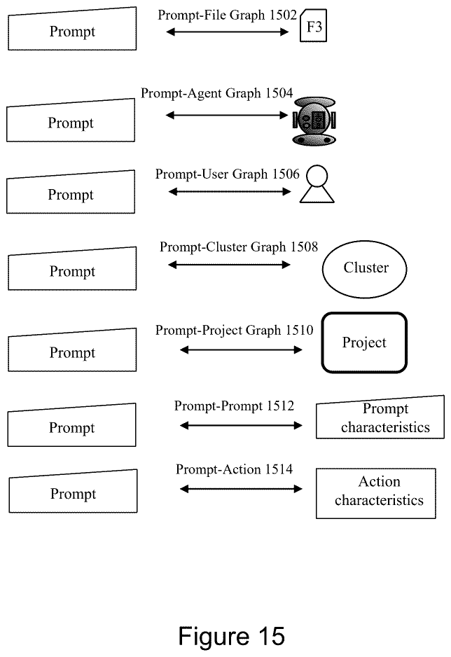

FIG. 15 shows relationship graphs that specifically pertain to prompts. The system may generate relationship graphs that include, for example, prompt-to-file graphs 1502, prompt-to-Agent graphs 1504, prompt-to-user graphs 1506, prompt-to-cluster graphs 1508, prompt-to-project graphs 1510, prompt-to-prompt graphs 1512, and/or prompt-to-action graphs 1514.

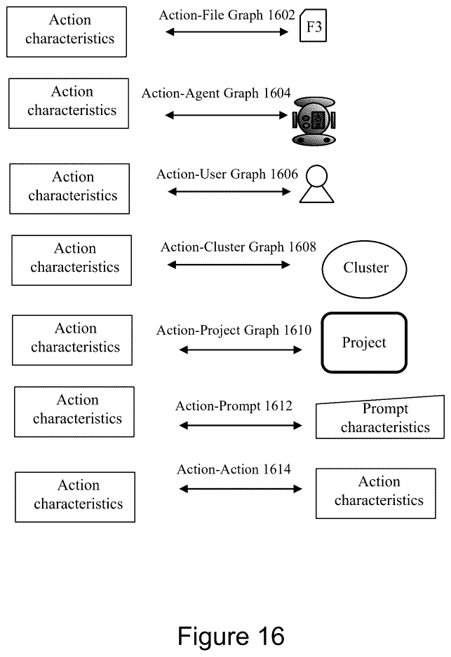

FIG. 16 shows relationship graphs that specifically pertain to actions. The system may generate relationship graphs that include, for example, action-to-file graphs 1602, action-to-Agent graphs 1604, action-to-user graphs 1606, action-to-cluster graphs 1608, action-to-project graphs 1610, action-to-prompt graphs 1612, and/or action-to-action graphs 1614.

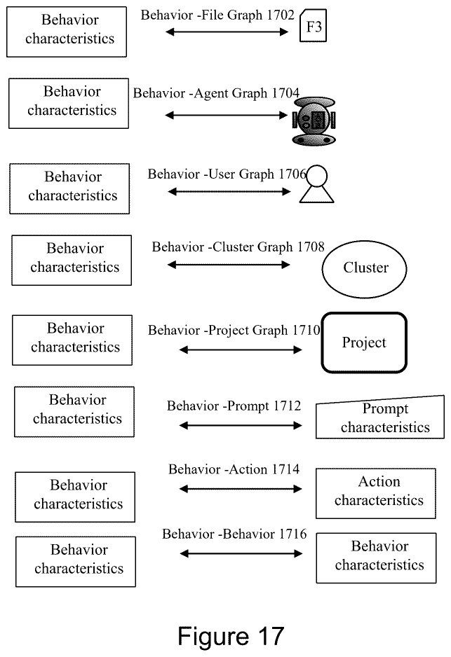

FIG. 17 illustrates example relationship graphs that pertain specifically to behaviors within the system. As used herein, a behavior corresponds to a collected set, sequence, or pattern of events, actions, results, or prompts that occur over time and may be analyzed collectively rather than individually. The system generates relationship graphs that model behaviors and their associations with other entities and objects within the system. Such relationship graphs may include, for example, behavior-to-file graphs 1702, behavior-to-agent graphs 1704, behavior-to-user graphs 1706, behavior-to-cluster graphs 1708, behavior-to-project graphs 1710, behavior-to-prompt graphs 1712, behavior-to-action graphs 1714, and behavior-to-behavior graphs 1716. These graphs enable the system to capture multi-step and cross-entity interactions that are not readily detectable through isolated prompt or action analysis.

One of the most challenging classes of malicious prompt injection attacks to identify involves indirect prompt injection. An indirect prompt injection attack occurs when an attacker embeds malicious instructions within external content, such as websites, documents, emails, data files, or metadata, that are later consumed or analyzed by an AI model or AI agent. This differs from direct prompt injection attacks, in which a malicious command is explicitly included within a prompt submitted to the AI. Direct prompt injection attacks may often be detected by analyzing the prompt itself, for example using the clustering and anomaly detection techniques described above. In contrast, indirect prompt injection attacks may reference data sources or destinations that appear legitimate, even though those sources may contain harmful or manipulated content.

By way of example, an indirect prompt injection attack may involve embedding harmful instructions or data within a publicly accessible website, an unsecured internal folder, a document such as a PDF file, or within metadata associated with a content object. An attacker may then cause an AI agent or LLM to access or analyze the compromised content, such that ingestion of the content results in unauthorized actions, execution of unintended instructions, or other undesirable behavior by the AI system. In such cases, neither the initiating prompt nor the accessed content may appear overtly malicious when evaluated in isolation.

In some instances, indirect prompt injection attacks may still be identified using the previously described anomaly detection techniques, for example when a prompt, action, or referenced location directly deviates from historical behavior patterns or corresponds to a known high-risk source. However, there exist scenarios in which no single prompt or action is sufficiently anomalous on its own to trigger detection, even though the combined effect of multiple actions or prompts results in malicious behavior.

Accordingly, some embodiments of the invention provide an enhanced approach in which sequences or collections of actions and prompts are analyzed as a unified behavior. Rather than focusing solely on individual prompts or actions, the system evaluates a behavior formed by a set or sequence of related interactions to determine whether the behavior as a whole deviates from established behavioral baselines. This behavior-level analysis enables detection of indirect prompt injection attacks that emerge only through a series of otherwise benign interactions.

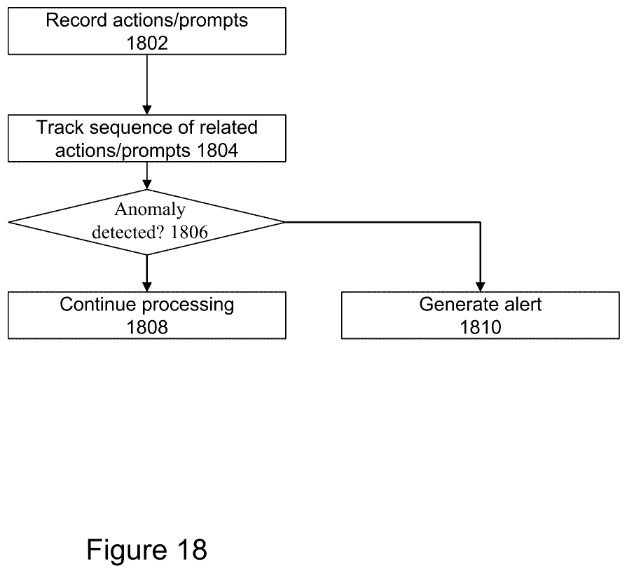

FIG. 18 illustrates a flowchart implementing one or more embodiments of behavior-level anomaly detection. At step 1802, the system records actions and/or prompts that are ingested, generated, or executed within the system by users, AI agents, or other entities. If any individual action or prompt is determined to be anomalous based on the techniques described above, an alert may be generated for that action or prompt.

At step 1804, the system identifies and tracks a set or sequence of related actions or prompts, which collectively define a behavior. A behavior may be defined in various ways, including but not limited to a sequence of actions performed by a single AI agent on behalf of a user, a chain of interactions involving multiple AI agents, or a workflow spanning multiple content objects and prompts. For example, a user instruction may cause a first AI agent to access external content, which then causes a second AI agent to process the content and initiate further actions. Any suitable criteria may be used to determine which actions or prompts are related and should be grouped together as a behavior. Any suitable timeframe may be used to evaluate behaviors, including such criteria over short or long time periods.

At step 1806, the system determines whether the identified behavior is anomalous by analyzing the characteristics of the behavior against previously generated clusters of behavior characteristics. The behavior characteristics may include, for example, the sequence and ordering of actions or prompts, temporal relationships between actions, types of content accessed, locations of accessed content, identities and roles of participating entities, and relationships between AI agents, users, and content objects. By evaluating these characteristics collectively, the system assesses whether the behavior as a whole aligns with established patterns of legitimate system usage.

In some embodiments, the comparison involves generating a vectorized or graph-based representation of the behavior and evaluating similarity to one or more behavior clusters using one or more similarity metrics, distance thresholds, or confidence scores. A behavior may be identified as anomalous when its representation does not sufficiently correspond to any existing behavior cluster, falls outside acceptable statistical bounds, or exhibits structural patterns that are inconsistent with historically observed behaviors. This enables detection of malicious activity that manifests only through a combination of otherwise benign actions or prompts.

If the system determines that the behavior conforms to known behavior clusters, processing proceeds normally at step 1808, and the actions associated with the behavior are allowed to continue or complete execution. In such cases, the behavior data may optionally be recorded and used to further refine or update the behavior clusters over time. Conversely, if the behavior is identified as anomalous, processing proceeds to step 1810, where one or more responsive actions are performed. Such actions may include generating an alert to a system administrator, restricting or blocking further execution of the behavior, requiring human review or approval, increasing monitoring or logging, or invoking additional security controls to mitigate a potential indirect prompt injection attack or other malicious activity.

Therefore, embodiments of the present invention provide systems and methods for detecting and mitigating malicious interactions involving artificial intelligence (AI), including prompt injection attacks, by analyzing historical interaction data rather than relying solely on static or rule-based safeguards. The disclosed techniques model AI behavior within its operational context by examining historical patterns of prompts, actions, content interactions, and entity relationships within a content management system (CMS). This context-aware analysis enables the system to identify deviations from established behavioral baselines that may indicate malicious or unintended manipulation of AI behavior. In some embodiments, the described technique is a purely mechanical approach that is itself not susceptible to manipulation/injection because it is not based on LLM's and therefore does not “interpret” any text like certain guard rail LLM's that analyze text.

The invention leverages machine learning-based clustering to derive behavioral groupings from historical activity data, including interactions involving human users, AI agents, prompts, content objects, and executed actions. These clusters represent normal or expected behavior patterns observed over time. When a new interaction operation is initiated—such as a prompt submission or an AI-initiated action—the system compares characteristics of the operation to the derived clusters to determine whether the operation aligns with known behaviors. Interactions that do not correspond to any existing cluster, or that fall outside acceptable similarity thresholds, may be identified as anomalous and indicative of a potential prompt injection or other malicious activity.

In contrast to prior art approaches that focus on automated guardrails, keyword filtering, or secondary AI models trained to detect malicious language, the present invention evaluates AI behavior holistically. Traditional guardrail-based systems are inherently limited by the flexibility of natural language and are susceptible to obfuscation techniques, such as indirect prompt injection, encoding, or metaphorical instruction. The disclosed invention overcomes these limitations by detecting anomalies in behavior rather than attempting to exhaustively enumerate malicious prompt patterns. As a result, the system remains effective even when malicious instructions are linguistically subtle or embedded within otherwise benign content.

An additional advantage of the disclosed approach is its adaptability over time. The clustering models and behavioral baselines may be updated dynamically as new interaction data is collected, allowing the system to distinguish between legitimate evolution in usage patterns and genuinely anomalous behavior. This adaptive learning capability reduces false positives while maintaining sensitivity to emerging attack techniques, thereby improving operational reliability and security posture without requiring constant manual updates to rule sets or detection heuristics.

Furthermore, the invention supports fine-grained, context-sensitive responses to detected anomalies. Upon identifying anomalous behavior, the system may generate alerts, restrict or block execution of suspicious operations, require additional authentication or human approval, or invoke enhanced monitoring and logging. These responses may be tailored based on the severity of the anomaly, the sensitivity of the affected content, or the role and permissions of the involved AI agent. This graduated response capability enables effective mitigation of potential threats while minimizing disruption to legitimate AI-assisted workflows.

Accordingly, embodiments of the present invention provide a technical improvement to AI security by shifting from prompt-level inspection to behavior-level anomaly detection grounded in historical system activity. By modeling how AI agents, prompts, and actions normally interact within a CMS and identifying deviations from those models, the invention offers a robust and scalable solution to prompt injection and related AI manipulation threats that overcomes the deficiencies of prior art systems.

### System Architecture Overview

### Additional System Architecture Examples

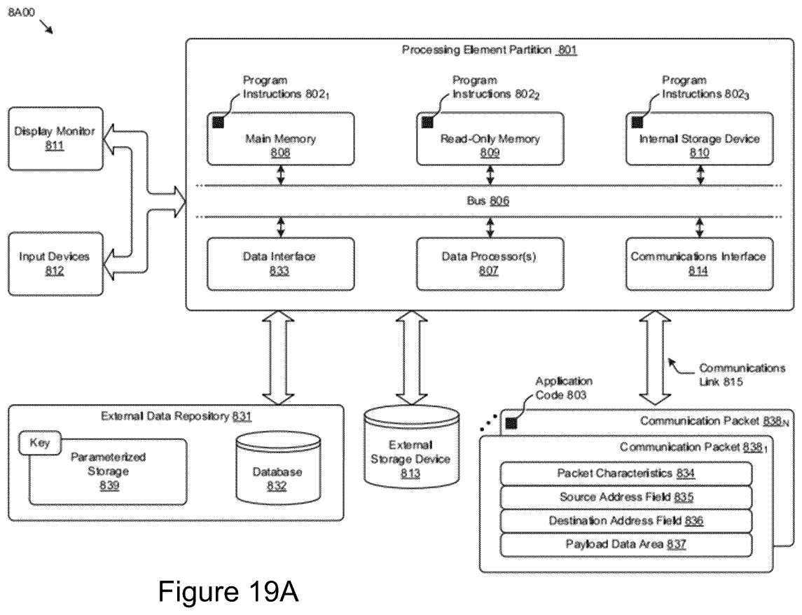

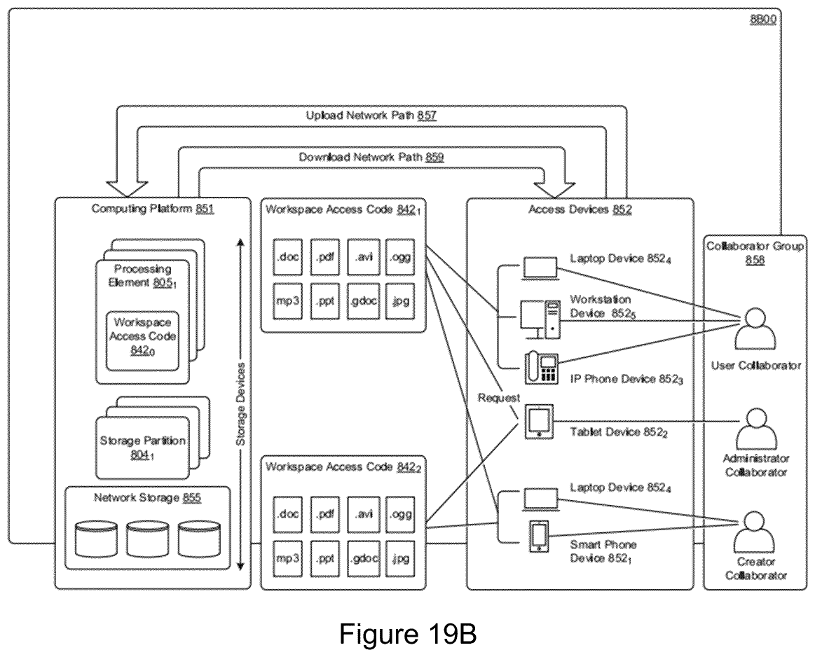

FIG. 19A depicts a block diagram of an instance of a computer system 8A00 suitable for implementing embodiments of the present disclosure. Computer system 8A00 includes a bus 806 or other communication mechanism for communicating information. The bus interconnects subsystems and devices such as a central processing unit (CPU), or a multi-core CPU (e.g., data processor 807), a system memory (e.g., main memory 808, or an area of random access memory (RAM)), a non-volatile storage device or non-volatile storage area (e.g., read-only memory 809), an internal storage device 810 or external storage device 813 (e.g., magnetic or optical), a data interface 833, a communications interface 814 (e.g., PHY, MAC, Ethernet interface, modem, etc.). The aforementioned components are shown within processing element partition 801, however other partitions are possible. Computer system 8A00 further comprises a display 811 (e.g., CRT or LCD), various input devices 812 (e.g., keyboard, cursor control), and an external data repository 831.

According to an embodiment of the disclosure, computer system 8A00 performs specific operations by data processor 807 executing one or more sequences of one or more program instructions contained in a memory. Such instructions (e.g., program instructions 802₁, program instructions 802₂, program instructions 802₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 8A00 performs specific networking operations using one or more instances of communications interface 814. Instances of communications interface 814 may comprise one or more networking ports that are configurable (e.g., pertaining to speed, protocol, physical layer characteristics, media access characteristics, etc.) and any particular instance of communications interface 814 or port thereto can be configured differently from any other particular instance. Portions of a communication protocol can be carried out in whole or in part by any instance of communications interface 814, and data (e.g., packets, data structures, bit fields, etc.) can be positioned in storage locations within communications interface 814, or within system memory, and such data can be accessed (e.g., using random access addressing, or using direct memory access DMA, etc.) by devices such as data processor 807.

Communications link 815 can be configured to transmit (e.g., send, receive, signal, etc.) any types of communications packets (e.g., communication packet 838₁, communication packet 838_{N}) comprising any organization of data items. The data items can comprise a payload data area 837, a destination address 836 (e.g., a destination IP address), a source address 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 831, which in turn can be formatted into any one or more storage areas, and which can comprise parameterized storage 839 accessible by a key (e.g., filename, table name, block address, offset address, etc.).

Execution of the sequences of instructions to practice certain embodiments of the disclosure are performed by a single instance of a computer system 8A00. According to certain embodiments of the disclosure, two or more instances of computer system 8A00 coupled by a communications link 815 (e.g., LAN, public switched telephone network, or wireless network) may perform the sequence of instructions required to practice embodiments of the disclosure using two or more instances of components of computer system 8A00.

Computer system 8A00 may transmit and receive messages such as data and/or instructions organized into a data structure (e.g., communications packets). The data structure can include program instructions (e.g., application code 803), communicated through communications link 815 and communications interface 814. Received program instructions may be executed by data processor 807 as it is received and/or stored in the shown storage device or in or upon any other non-volatile storage for later execution. Computer system 8A00 may communicate through a data interface 833 to a database 832 on an external data repository 831. Data items in a database can be accessed using a primary key (e.g., a relational database primary key).

Processing element partition 801 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 807. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to accessing a dynamically extensible set of content object workflows. A module may include one or more state machines and/or combinational logic used to implement or facilitate the operational and/or performance characteristics pertaining to accessing a dynamically extensible set of content object workflows.

Various implementations of database 832 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of accessing a dynamically extensible set of content object workflows). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations that pertain to accessing a dynamically extensible set of content object workflows, and/or for improving the way data is manipulated when performing computerized operations pertaining to accessing a dynamically extensible set of applications through a content management system to perform workflows over content objects managed by the content management system.

FIG. 19B depicts a block diagram of an instance of a cloud-based environment 8B00. Such a cloud-based environment supports access to workspaces through the execution of workspace access code (e.g., workspace access code 842₀, workspace access code 842₁, and workspace access code 842₂). Workspace access code can be executed on any of access devices 852 (e.g., laptop device 852₄, workstation device 852₅, IP phone device 852₃, tablet device 852₂, smart phone device 852₁, etc.), and can be configured to access any type of object. Strictly as examples, such objects can be folders or directories or can be files of any filetype. A group of users can form a collaborator group 858, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 851, including in a middleware setting. As shown, a portion of the workspace access code resides in and can be executed on one or more processing elements (e.g., processing element 805₁). The workspace access code can interface with storage devices such as networked storage 855. Storage of workspaces and/or any constituent files or objects, and/or any other code or scripts or data can be stored in any one or more storage partitions (e.g., storage partition 804₁). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 857). A stored workspace can be delivered to a particular user and/or shared with other particular users via a download (e.g., a download from a processing element to an access device over a download network path 859).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
recording historical interaction data associated with a content management system;
performing clustering on the historical interaction data to generate a plurality of behavioral clusters;
identifying a new interaction operation associated with a prompt or an AI-initiated action;
generating a vector representation of characteristics of the new interaction operation;
determining whether the vector representation corresponds to at least one of the plurality of behavioral clusters; and
identifying the new interaction operation as anomalous when the vector representation does not correspond to any of the plurality of behavioral clusters.

2. The method of claim 1, wherein the historical interaction data comprises at least one of prompt characteristics, action characteristics, and content object characteristics.

3. The method of claim 1, wherein performing machine learning-based clustering comprises generating clusters corresponding to historical prompt usage patterns.

4. The method of claim 1, wherein the vector representation includes contextual information associated with the new interaction operation corresponding to a prompt.

5. The method of claim 1, wherein identifying the new interaction operation comprises identifying a prompt generated by an AI agent.

6. The method of claim 1, further comprising generating an alert in response to identifying the anomalous interaction operation.

7. The method of claim 1, further comprising preventing execution of the new interaction operation in response to identifying the anomalous interaction operation.

8. The method of claim 1, wherein a relationship graph is generated that maps at least one of: (a) AI agent to an entity, object, prompt, or action; (b) prompt to an entity, object, prompt, or action; or (c) action to an entity, object, prompt, or action.

9. A non-transitory computer readable medium having stored thereon a sequence of instructions which, when stored in memory and executed by one or more processors causes the one or more processors to perform a set of acts, the set of acts comprising:
recording historical interaction data associated with a content management system;
performing machine learning-based clustering on the historical interaction data to generate a plurality of behavioral clusters;
identifying a new interaction operation associated with a prompt or an AI-initiated action;
generating a vector representation of characteristics of the new interaction operation;
determining whether the vector representation corresponds to at least one of the plurality of behavioral clusters; and
identifying the new interaction operation as anomalous when the vector representation does not correspond to any of the plurality of behavioral clusters.

10. The computer readable medium of claim 9, wherein the historical interaction data comprises at least one of prompt characteristics, action characteristics, and content object characteristics.

11. The computer readable medium of claim 9, wherein performing machine learning-based clustering comprises generating clusters corresponding to historical prompt usage patterns.

12. The computer readable medium of claim 9, wherein the vector representation includes contextual information associated with the new interaction operation corresponding to a prompt.

13. The computer readable medium of claim 9, wherein identifying the new interaction operation comprises identifying a prompt generated by an AI agent.

14. The computer readable medium of claim 9, further comprising generating an alert in response to identifying the anomalous interaction operation.

15. The computer readable medium of claim 9, further comprising preventing execution of the new interaction operation in response to identifying the anomalous interaction operation.

16. The computer readable medium of claim 9, wherein a relationship graph is generated that maps at least one of: (a) AI agent to an entity, object, prompt, or action; (b) prompt to an entity, object, prompt, or action; or (c) action to an entity, object, prompt, or action.

17. A system comprising:
a storage medium having stored thereon a sequence of instructions; and
one or more processors that execute the sequence of instructions to cause the one or more processors to perform a set of acts, the set of acts comprising: recording historical interaction data associated with a content management system; performing machine learning-based clustering on the historical interaction data to generate a plurality of behavioral clusters; identifying a new interaction operation associated with a prompt or an AI-initiated action; generating a vector representation of characteristics of the new interaction operation; determining whether the vector representation corresponds to at least one of the plurality of behavioral clusters; and identifying the new interaction operation as anomalous when the vector representation does not correspond to any of the plurality of behavioral clusters.

18. The system of claim 17, wherein the historical interaction data comprises at least one of prompt characteristics, action characteristics, and content object characteristics.

19. The system of claim 17, wherein performing machine learning-based clustering comprises generating clusters corresponding to historical prompt usage patterns.

20. The system of claim 17, wherein the vector representation includes contextual information associated with the new interaction operation corresponding to a prompt.

21. The system of claim 17, wherein identifying the new interaction operation comprises identifying a prompt generated by an AI agent.

22. The system of claim 17, further comprising generating an alert in response to identifying the anomalous interaction operation.

23. The system of claim 17, further comprising preventing execution of the new interaction operation in response to identifying the anomalous interaction operation.

24. The system of claim 17, wherein a relationship graph is generated that maps at least one of: (a) AI agent to an entity, object, prompt, or action; (b) prompt to an entity, object, prompt, or action; or (c) action to an entity, object, prompt, or action.

25. A method, comprising:
recording actions and prompts performed within a content management system;
grouping a sequence of related actions or prompts into a behavior;
identifying one or more behavior-level clusters based on historical sequences of actions or prompts;
comparing a representation of the behavior to the behavior-level clusters; and
identifying the behavior as anomalous when the representation does not correspond to any of the behavior-level clusters;
wherein the behavior is identified as anomalous even though individual actions or prompts within the behavior are not identified as anomalous.
